(19) United States
(12) Patent Application Publication
(10) Pub. No.: US 2014/0194111 A1
(43) Pub. Date: Jul. 10, 2014

(54) COMMUNICATION SYSTEM, USER TERMINAL, AND COMMUNICATION DEVICE

(71) Applicants: Keigo Aso, Osaka (JP); Hidenori Matsuo, Kanagawa (JP); Takahisa Aoyama, Kanagawa (JP)

(72) Inventors: Keigo Aso, Osaka (JP); Hidenori Matsuo, Kanagawa (JP); Takahisa Aoyama, Kanagawa (JP)

(73) Assignee: PANASONIC CORPORATION, Osaka (JP)

(21) Appl. No.: 14/127,676

(22) PCT Filed: Jun. 13, 2012
(86) PCT No.: PCT/JP2012/003850

§ 371 Date: Dec. 19, 2013

(30) Foreign Application Priority Data
Jun. 30, 2011 (JP) 2011-146700
Oct. 3, 2011 (JP) 2011-219256

(51) Int. Cl. H04W 8/22

(52) U.S. Cl. CPC H04W 8/22
USPC 455/419

(57) ABSTRACT

Disclosed is a technique for starting an application used to receive a message for the application efficiently in order to reduce the processing load on and the battery consumption of a user terminal. According to this technique, a network is requested to transmit a control message to a user terminal when receiving a message addressed to an application on the user terminal, and when receiving, from a server, a message addressed to the application on the user terminal, the network transmits a control message such as paging to the user terminal. The user terminal receives the paging from the network even in the connected mode, and starts an application used to receive a message for the application on the user terminal in response to the reception of the paging so that the application can be started at timing where there exists the message to be received.

### TECHNICAL FIELD

The disclosed technique relates to a communication system, a user terminal, and a communication device for performing communication using a cellular communication function.

### BACKGROUND ART

There are a variety of services available through a terminal (hereinafter UE User Equipment) using cellular communications, such as a cellular phone or a smartphone. Services used by installing necessary applications (hereinafter, each of which may also be referred to as “app” in this specification) at user's discretion are spreading, such as a navigation service using an electronic map and a voice call service through Internet access as well as Web access and E-Mail services. These various applications are started on a UE, but how the applications run is different depending on the forms of services. For example, there is an application that starts running through a user's operation such as a Web access application, while there is an application that is always waiting for an incoming call from any other user such as a voice call application. In the latter case, since the application does not know when a message addressed to the application is transmitted, there is a need to keep the application always running to wait until the message is received.

Particularly, among applications used in communication between machines (called Machine to Machine Communication or Machine Type Communication, which is referred to as MM communication below), since there is an application required to give notice of sensing data (e.g. air temperature, seismic intensity, water content, camera, GPS (Global Positioning System)) by request from a server or a node within a cellular network or any other UE, there is a need to keep the application always running to respond to the reception of a message transmitted on an irregular base. For example, an application is considered which causes a smartphone receiving an inquiry from a server or any other UE when a user carrying the smartphone is driving a car to notify the server of GPS position information. Note that the UE is a terminal equipped with a cellular communication function, including a car navigation device with a communication function, a PND (Portable Navigation Device), a pedestrian navigation device, or a M2M service-specific communication device as well as the cellular phone or the smartphone.

### PRIOR ART DOCUMENTS

### Non-Patent Documents

Non-Patent Document 1: “3rd Generation Partnership Project; Technical Specification Group Services and System Aspects: System Improvements for Machine-Type Communications,” 3GPP TR 23.888, V1.3.0, June 2011.

Non-Patent Document 2: “3rd Generation Partnership Project; Technical Specification Group Services and System Aspects; Service requirements for machine-type communications,” 3GPP TS 22.368, V11.1.0, March 2011.

### SUMMARY OF THE INVENTION

The UE cannot receive any message for the application sent from the server or a node within a cellular network or any other UE unless the application is running. However, if the application is kept always running, the CPU power or the memory of the UE will be consumed, and a battery of the UE will also be consumed. Particularly, in order to receive a request originated irregularly or in an unexpected fashion due to the convenience of the communication partner, such as a data transmission request or incoming call standby, a corresponding application needs to be kept always running. Thus, there is a problem that keeping the application always running to wait for a request that is uncertain when it comes is not efficient.

In order to solve the above problems, according to one aspect of the disclosed technique, for example, there is provided a technique for enabling a user terminal to start an application used to receive and process a message for the application even when receiving the message for the application from a terminal as a communication partner, such as a server or any other user terminal, while the application is not running.

For example, one aspect of the disclosed technique is a communication system comprising a user terminal, a network device including a network entity that is an element of a network, and a predetermined communication device as a communication partner of the user terminal,

wherein

the predetermined communication device includes
a message transmission unit for transmitting, to the network, a request message including application identification information for identifying an application on the user terminal, the request message requesting the network device to transmit a control message to the user terminal,

the network device includes
a control message transmitting unit for transmitting a control message including the application identification information to the user terminal when receiving the request message from the predetermined communication device as the communication partner of the user terminal, the control message being generated based on the request message, and

the user terminal includes
a control message receiving unit for receiving the control message from the network, and
an application starting unit for starting an application identified by the application identification information when the control message is received at the control message receiving unit.

According to the above configuration, the user terminal can start an application used to receive and process a message for the application before receiving the message for the application from a terminal as a communication partner such as a server or any other user terminal.

Aspects of the disclosed technique may be implemented by a user terminal and a communication device in addition to the communication system mentioned above.

For example, the disclosed technique has the above configuration to enable the user terminal to start an application used to receive and process a message for the application before receiving the message for the application from a terminal as a communication partner such as a server or any other user terminal, having the effects of reducing the processing load on and the battery consumption of the user terminal.

Note that the effects and advantages of the disclosed technique are not limited to those mentioned above. Further effects and advantages will become apparent from the disclosed contents of the specification and the drawings. For example, the further effects and advantages mentioned above are provided individually by various embodiments and features disclosed in the specification and the drawings, and all effects and advantages do not necessarily need to be provided by one aspect of the disclosed technique.

### BRIEF DESCRIPTION OF THE DRAWINGS

FIG. 1 is a diagram showing an example of a network configuration in a first embodiment of the disclosed technique.

FIG. 2 is a sequence chart showing an example of the operation of a UE, a network, and a server in the first embodiment of the disclosed technique.

FIG. 3 is a flowchart showing an example of processing performed by the network when a packet addressed to the UE is received from an MTC server in the first embodiment of the disclosed technique.

FIG. 4 is a flowchart showing an example of processing performed by the UE when receiving a control message in the first embodiment of the disclosed technique.

FIG. 5 is a sequence chart showing an example of processing when the network uses a paging message as the control message indicative of a packet reception notification to be transmitted to the UE in the first embodiment of the disclosed technique.

FIG. 6 is a flowchart showing an example of processing performed by the UE when receiving the paging message in the first embodiment of the disclosed technique.

FIG. 7 is a block diagram showing an example of the configuration of the UE in the first embodiment of the disclosed technique.

FIG. 8 is a block diagram showing an example of the configuration of the network in the first embodiment of the disclosed technique.

FIG. 9 is a diagram showing an example of a network configuration representing in detail entities existing within the network in the first embodiment of the disclosed technique.

FIG. 10 is a block diagram showing an example of the configuration of an IWF in the first embodiment of the disclosed technique.

FIG. 11 is a block diagram showing an example of the configuration of the MTC server in the first embodiment of the disclosed technique.

FIG. 12 is a sequence chart showing an example of transmitting a message through the IWF in the first embodiment of the disclosed technique.

FIG. 13 is a flowchart showing an example of processing performed by a PGW when the GTP protocol is used in the first embodiment of the disclosed technique.

FIG. 14 is a flowchart showing an example of processing performed by an SGW when the GTP protocol is used in the first embodiment of the disclosed technique.

FIG. 15 is a flowchart showing an example of processing performed by the SGW when the PMIP protocol is used in the first embodiment of the disclosed technique.

FIG. 16 is a diagram schematically showing an example of a control message for a paging request in the first embodiment of the disclosed technique.

FIG. 17 is a diagram schematically showing an example of a control message for a paging response in the first embodiment of the disclosed technique.

FIG. 18 is a diagram showing an example of bearer IDs assigned to bearers established between the UE and the network in a second embodiment of the disclosed technique.

FIG. 19 is a sequence chart showing an example of processing in which a message for application B is received from server B when control message transmission requests related to application A and application B are registered in the second embodiment of the disclosed technique.

FIG. 20 is a sequence chart showing an example of processing when the server adds a paging transmission request as a control message transmission request into a trigger message to be transmitted to the IWF in a third embodiment of the disclosed technique.

FIG. 21 is a diagram showing an example of a method using a resident application for detecting that a packet addressed to application A has arrived on the UE in a fourth embodiment of the disclosed technique.

FIG. 22 is a sequence chart showing an example when the IWF directly instructs an MME to transmit paging in the third embodiment of the disclosed technique.

FIG. 23 is a sequence chart showing an example when the IWF directly instructs the MME to transmit paging in the first embodiment of the disclosed technique.

FIG. 24 is a sequence chart showing an example when paging is used as the control message to trigger data transmission from the UE in the third embodiment of the disclosed technique.

FIG. 25 is a sequence chart showing an example when SMS is used as the control message to trigger data transmission from the UE in the third embodiment of the disclosed technique.

FIG. 26 is a sequence chart showing an example when paging is used as the control message to trigger data transmission from the UE in the first embodiment of the disclosed technique.

FIG. 27 is a sequence chart showing an example when SMS is used as the control message to trigger data transmission from the UE in the first embodiment of the disclosed technique.

FIG. 28 is a diagram schematically showing a trigger message transmitted from the server in the third embodiment of the disclosed technique.

FIG. 29 is a sequence chart showing an example when SMS is used as the control message in the first embodiment of the disclosed technique.

FIG. 30 is a sequence chart showing an example when SMS is used as the control message in the third embodiment of the disclosed technique.

FIG. 31 is a sequence chart showing an example when the IWF instructs a CBC to transmit a CBS message as the control message in the first embodiment of the disclosed technique.

FIG. 32 is a sequence chart showing an example when CBS is used as the control message to trigger data transmission from the UE in the first embodiment of the disclosed technique.

FIG. 33 is a sequence chart showing an example when the server includes, in a trigger message, information (control message transmission request) for giving an instruction to use a CBS message and transmits the trigger message to the IWF, and the IWF selects the use of CBS in the third embodiment of the disclosed technique.

FIG. 34 is a sequence chart showing an example when the server includes, in a trigger message, information (control message transmission request) for giving an instruction to use a CBS message and transmits the trigger message to the IWF, and the IWF selects the use of CBS to trigger data transmission from the UE in the third embodiment of the disclosed technique.

FIG. 35 is a sequence chart showing an example when the server includes a CBS transmission request in a trigger message and transmits the trigger message in response to receiving an application stop notification from the UE in FIG. 34.

### DESCRIPTION OF EMBODIMENTS

First to fourth embodiments of the disclosed technique will be described below with reference to the accompanying drawings. In the first embodiment of the disclosed technique, when a UE registering a control message transmission request for the reception of a specific packet receives a control message, an application associated with the control message transmission request is started. In the second embodiment of the disclosed technique, when multiple applications are installed on the UE, an application to be started is identified using a bearer ID (EPS bearer ID, bearer identifier). In the third embodiment of the disclosed technique, the control message transmission request is added into a packet transmitted from a server. In the fourth embodiment of the disclosed technique, a resident app for monitoring the reception of a packet addressed to application A is used to start application A when the reception of the packet addressed to application A is detected.

### First Embodiment

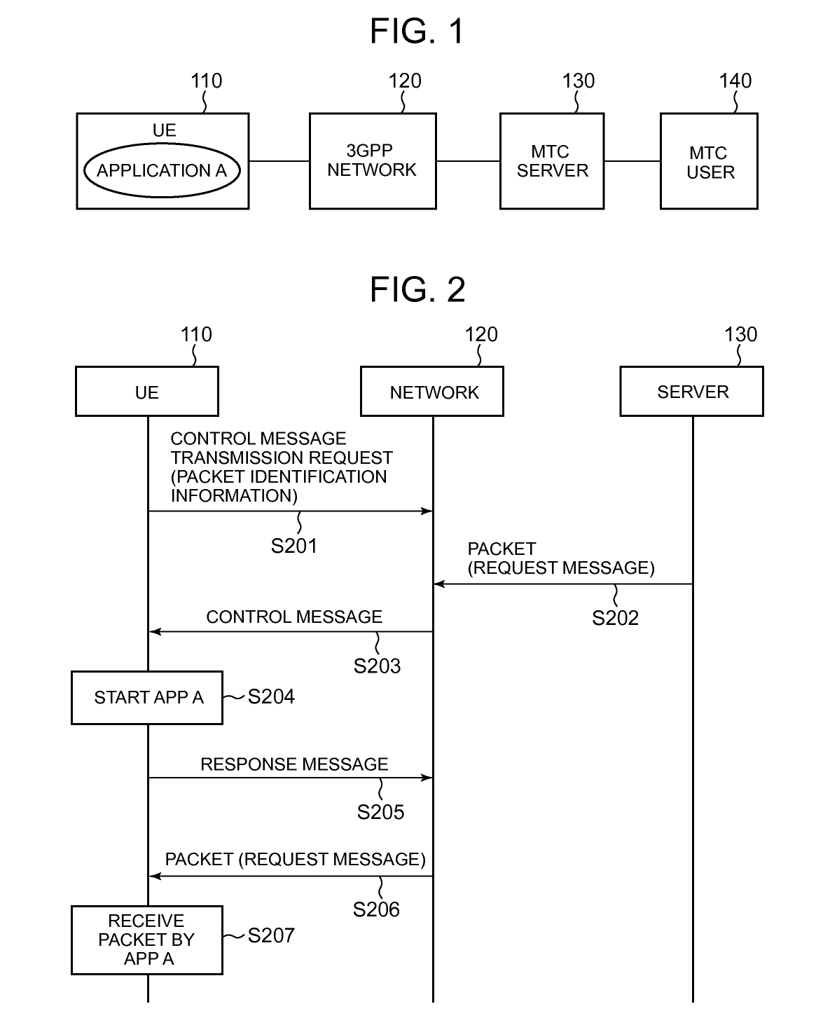

First, the first embodiment of the disclosed technique will be described. FIG. 1 is a diagram showing an example of a network configuration in the first embodiment of the disclosed technique. Illustrated in FIG. 1 are a UE 110 as a cellular communication terminal, an MTC server (which may be simply referred to as a server below) 130 for performing communication with the UE 110, a 3GPP network (which may be simply referred to as a network below) 120 that forms a cellular communication network connecting the UE 110 and the MTC server 130, and an MTC user 140 for performing management and control of a service provided on the MTC server 130. Note that the MTC server 130 may exist in the 3GPP network 120.

Here, it is assumed that application A is installed on the UE 110 to perform communication with the MTC server 130 using application A. The UE 110 is registered with the network 120, and a connection (PDP context/PDN Connection) and a bearer required to transmit and receive packets for application A are established between the network 120 and the UE 110. The UE 110 is in either an idle mode or a connected mode. The UE 110 in the idle mode halts the operation of a transmission circuit, but keeps a reception circuit working to receive a control message called paging and the like. In response to receiving the control message, the UE 110 moves to the connected mode for activating both the transmission circuit and the reception circuit to perform normal communication. The UE 110 does not need to keep the application always running in both the idle mode and the connected mode, and can quit and start the application arbitrarily even if the connection is established. When the UE 110 is configured to include an ACPU (Application CPU) and a CCPU (Communication CPU), the UE 110 quits the application to stop the operation of the ACPU so as to operate only the CCPU, enabling a reduction in power consumption associated with the operation of the ACPU.

The MTC server 130 can transmit a packet (request message for application A) to the UE 110 through the established connection and bearer. In the specification, the MTC server 130 is assumed as a communication device that is a communication partner of the UE 110, but the communication partner of the UE 110 is not limited to the MTC server 130. The communication partner may be a node within the cellular network or any other UE 110. LTE/SAE, UMTS, or GPRS/GSM (registered trademark), or further WiMAX (registered trademark) or mobile WiMAX may be used as the 3GPP network 120 shown in FIG. 1. In either case, the name of each of the various entities conforms to the specifications.

FIG. 2 is a sequence chart showing an example of the operation of the UE 110, the network 120, and the server 130 in the first embodiment of the disclosed technique. In FIG. 2, the UE 110 first transmits a control message transmission request to the network 120 (step S201). This control message transmission request is a message for requesting the network 120 to transmit a control message to the UE 110 when the network 120 receives a specific packet (request message for application A) addressed to the UE 110 from the server 130. When application A is not started, the UE 110 transmits the control message transmission request to the network 120 to receive a control message indicating that a packet for application A is transmitted from the server 130. For example, a message for this control message transmission request is transmitted when the UE 110 is quitting application A, or has quit application A, or is about to quit application A. As will be described later, the packet transmitted from the server 130 may be a trigger request message (which may also be called a trigger message), and the operation of the UE 110 performed in response to receiving the control message may be to start data transmission, to attach to the network, or further to establish a connection in addition to starting application A. The control message transmission request may also be transmitted when there is a need to reduce the processing load to receive packets even if application A is running. In this case, since the message for triggering the operation of the UE 110 can be set as a message on a control plane (C-plane), the load on the network due to the message on a user plane and processing load on the UE 110 can be reduced. This control message transmission request includes information (packet identification information) for identifying a packet (request message for application A) from the server 130, and information (control message request) for making a request for transmission of the control message to the UE 110 when a packet corresponding to the packet identification information (packet filter) is received. The network 120 that received the control message transmission request holds, as filter information, information included in the control message transmission request. Note that the packet identification information is information for making the packet identifiable as the packet from the server 130. For example, the address or a port number of the server 130, information for identifying the application, or APN (Access Point Name) can be used as the packet identification information. When there is no packet filter corresponding to the packet received from the server 130, the network 120 can recognize that the packet is a packet for which the control message is to be transmitted. In this case, the UE 110 transmits, in step S201, a message for deleting the packet filter related to the packet for which the control message is to be transmitted.

After receiving the packet from the server 130 (step S202), when the network 120 confirms the existence (holding) of filter information set for this packet, this packet is buffered, and a control message (packet reception notification) to give notice of having received the packet for application A from the server 130 (i.e., the fact that the packet addressed to the UE 110 exists) is transmitted to the UE 110 (step S203). The UE 110 that received the control message indicative of the packet reception notification from the network 120 starts application A (step S204) and transmits a response message to the network 120 (step S205). The network 120 that received the response message forwards the buffered packet to the UE 110 (step S206). Since application A is already running, the UE 110 can receive and process the forwarded packet by application A (step S207). When information in the packet can be included in the control message to be transmitted to the UE 110, since the UE 110 can perform a specific operation based on the information included in the control message (such as to start the application, to start data transmission, to attach to the network, or further to establish a connection), the network 120 does not need to buffer or forward the packet.

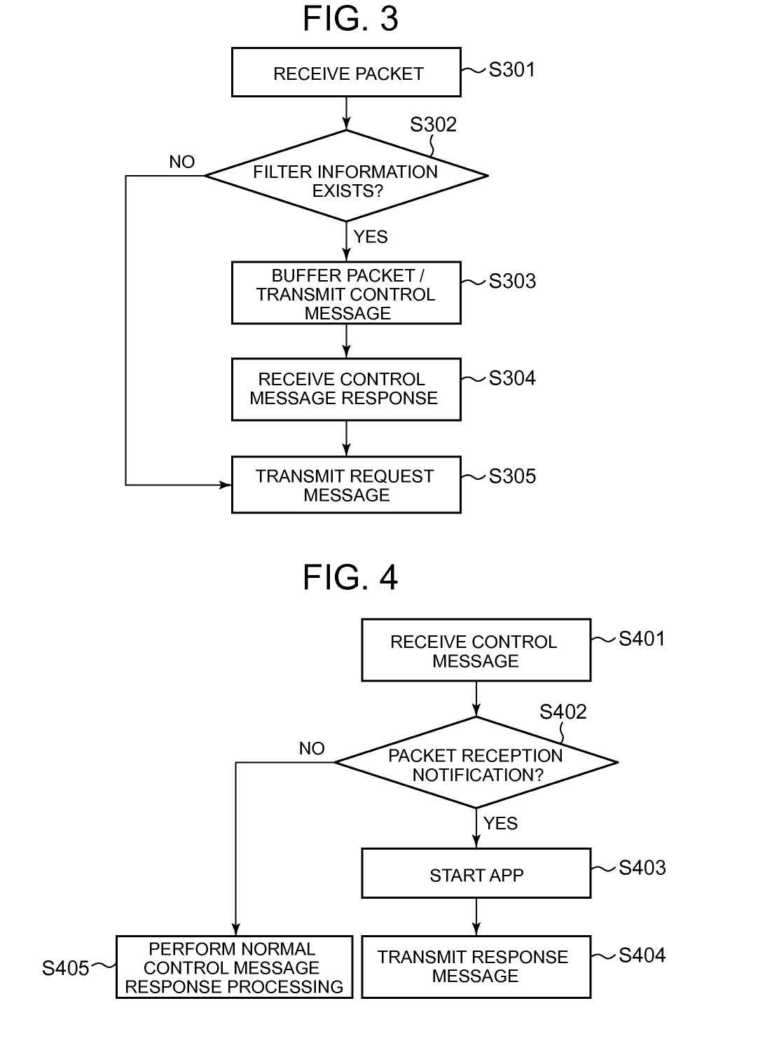

FIG. 3 is a flowchart showing an example of processing performed by the network 120 when a packet addressed to the UE 110 is received from the MTC server 130 in the first embodiment of the disclosed technique. The processing in FIG. 3 corresponds to the processing performed by the network 120 from when receiving the packet in step S202 of FIG. 2 until the control message is transmitted to the UE 110 in step S203. In FIG. 3, when receiving a packet addressed to the UE 110 from the server 130 (step S301), the network 120 checks whether filter information corresponding to the packet exists (whether the filter information is registered with the network 120) (step S302).

When filter information corresponding to the packet exists, the network 120 buffers the packet, rather than transmitting the packet to the UE 110, even when the UE 110 is in the connected mode, and transmits a control message to the UE 110 (step S303). In other words, even when a bearer used to transmit the packet addressed to the UE 110 exists and the UE 110 is in the connected mode, the network 120 transmits the control message without transmitting the packet to the UE 110 immediately using the bearer.

When receiving the control message, the UE 110 starts application A and returns a response message to the control message. The network 120 receives this response message to the control message (step S304), and forwards the buffered packet to the UE 110 (step S305). Since the UE 110 already runs application A, the forwarded packet can be received and processed by application A. When no filter information corresponding to the packet exists in step S302, the network 120 may consider that the UE 110 already runs application A, and hence forward the packet to the UE 110 immediately. Further, for example, when receiving the response message in step S304, the network 120 may delete the filter information corresponding to this packet.

FIG. 4 is a flowchart showing an example of processing performed by the UE 110 when receiving the control message in the first embodiment of the disclosed technique. The processing in FIG. 4 corresponds to the processing performed by the UE 110 after receiving the control message in step S203 of FIG. 2. When receiving the control message (step S401), the UE 110 checks whether the received control message is a control message indicative of a packet reception notification (step S402). When it is the control message indicative of the packet reception notification, the UE 110 starts application A (step S403) and returns a response message to the control message (step S404). On the other hand, when the received control message is not the packet reception notification, normal control message response processing is performed (step S405). The UE 110 may determine that the received control message is the packet reception notification when a registered packet filter exists or when information indicative of the packet reception notification is included in the received control message.

As the control message transmission request, an existing control message (NAS (Non-Access Stratum) message or AS (Access Stratum) message), such as a message (BEARER RESOURCE ALLOCATION REQUEST, BEARER RESOURCE MODIFICATION REQUEST) for establishing or changing the default bearer or a dedicated bearer, a message (Activate PDP Context Request, Modify PDP Context Request, PDN CONNECTIVITY REQUEST, PDN DISCONNECT REQUEST) for establishing or changing a PDP context/PDN connection, a message (Routing Area Update, Tracking Area Update) for updating service area information, or a service request message (Service request), or a dedicated message can be used. As the control message transmitted from the network 120 to the UE 110, a broadcastimulticast/unicast message capable of being transmitted to the UE 110, such as a paging message, CBS (Cell Broadcast Service), MBMS (Multimedia Broadcast and Multicast Service), or SMS (Short Message Service) can be used. Further, as the control message transmitted from the network 120 to the UE 110, notification information such as SIB (System Information Block) transmitted from a base station can also be used. In this case, if information indicative of the presence of absence of SIB is included in paging when receiving paging, the UE 110 will check on corresponding SIB. Then, when information indicative of a packet reception notification is included therein, the UE 110 starts application A and returns a response message.

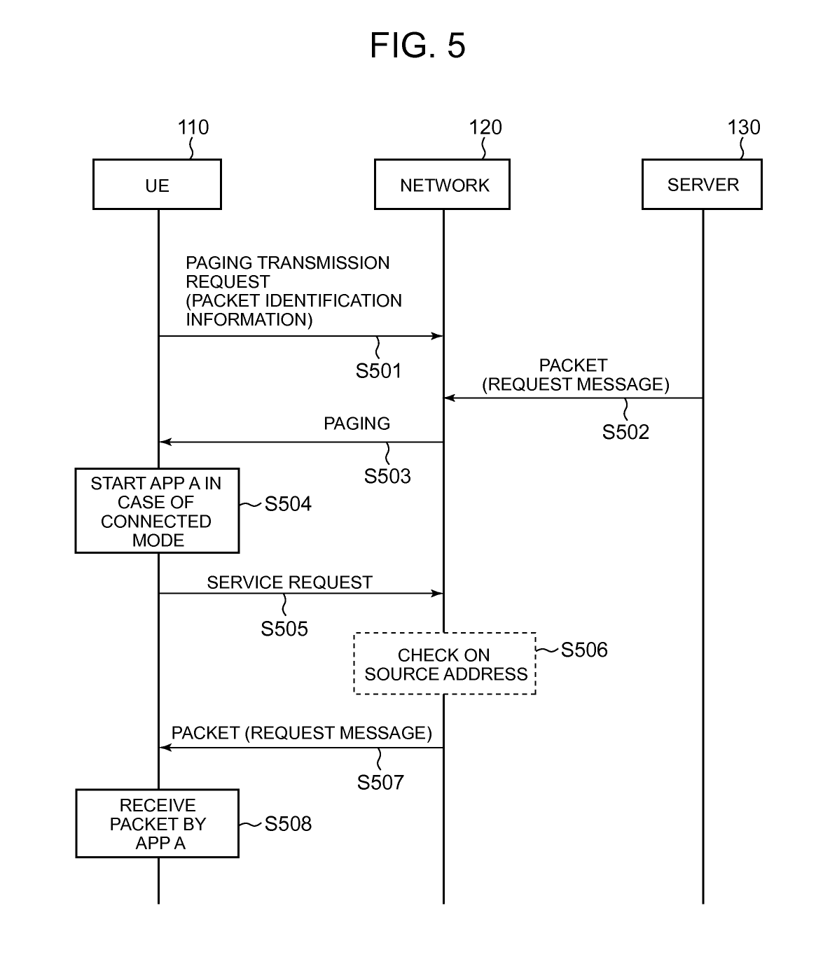

FIG. 5 is a sequence chart showing an example of processing when the network 120 uses a paging message as the control message indicative of the packet reception notification to be transmitted to the UE 110 in the first embodiment of the disclosed technique. The UE 110 transmits, for example, a Bearer Modification Request (bearer change request) message as the control message transmission request (paging transmission request) (step S501) to make a request for transmission of paging for the message from the server 130. The Bearer Modification Request message includes a packet filter including packet identification information for identifying a packet from the server 130 as information held as a TFT (Traffic Flow Template) within the network 120, a bearer identifier (EPS Bearer Identifier, bearer ID) used to transmit the packet, and the paging transmission request. The network 120 that received the Bearer Modification Request message holds, as the TFT, information included in the message.

Then, when receiving the packet addressed to the UE 110 (step S502), if there is a packet filter corresponding to the packet, the network 120 will identify a bearer used for transmission and reception from the bearer ID associated with the packet filter. The packet is generally forwarded using the identified bearer, but when the paging transmission request is added to the packet filter, the network 120 in the embodiment buffers the packet, rather than transmitting the packet to the UE 110, even if the UE 110 is in the connected mode, and transmits a paging message (step S503). The UE 110 that received the paging message from the network 120 starts application A for receiving and processing the packet from the server 130 (step S504), and transmits a response message (service request message) (step S505). The network 120 that received the service request message forwards the buffered packet to the UE 110 (step S507). At this time, for example, the source address of the buffered packet may be checked to check whether this packet corresponds to packet identification information included in the service request message received from the UE 110 (step S506). Since the UE 110 runs application A in step S504, the forwarded packet can be received (step S508).

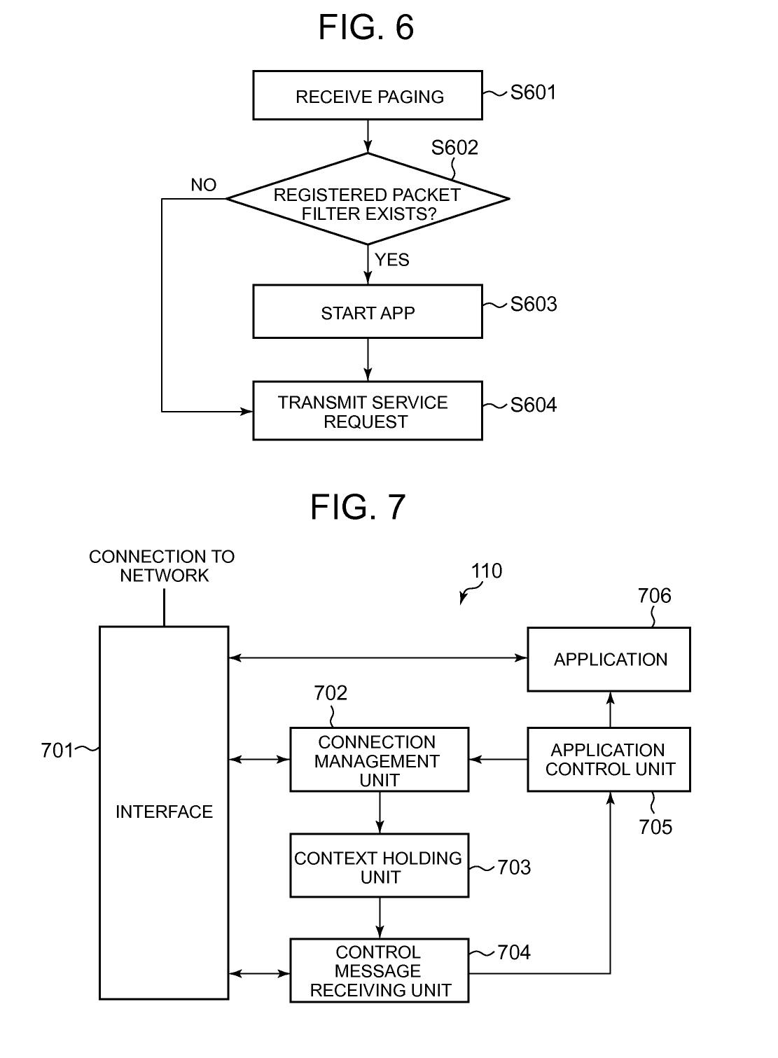

FIG. 6 is a flowchart showing an example of processing performed by the UE 110 when receiving a paging message in the first embodiment of the disclosed technique. The processing in FIG. 6 corresponds to the processing performed by the UE 110 from when receiving the paging message in step S503 of FIG. 5 until the service request message is transmitted in step S505. When the paging message is used as the control message, the UE 110 in the connected mode checks whether a registered packet filter exists (step S602), and when the registered packet filter exists, the UE 110 determines that the paging message as the control message is a packet reception notification indicating that the packet has been received from the server 130. Then, when determining that the paging message is the packet reception notification, the UE 110 starts application A (step S603) and transmits a service request message (step S604). On the other hand, when no registered packet filter exists, the UE 110 in the connected mode does not perform reception processing unless an ETWS (Earthquake and Tsunami Warning service) flag or an SIB (System Information Block) change flag is set in the paging received. Even when the UE 110 is in the idle mode in FIG. 6, if the registered packet filter exists, the UE 110 will also start application A and transmit the service request. On the other hand, when no packet filter exists, the UE 110 transmits the service request message without starting the application. In the case of use of SMS as the control message, when receiving SMS, if the UE 110 in the connected mode determines that the SMS is the packet reception notification, the UE 110 will start application A and transmit an SMS reception response. On the other hand, when the UE 110 is in the idle mode, the UE 110 receives paging, and receives the SMS after transmitting a service request. The SMS reception response is not limited to the service request, and it may be SMS or an IP packet addressed to the network 120 or the server 130.

FIG. 7 is a block diagram showing an example of the configuration of the UE 110 in the first embodiment of the disclosed technique. The UE 110 includes an interface 701, a connection management unit 702, a context holding unit 703, a control message receiving unit 704, an application control unit 705, and an application 706. The connection management unit 702 has the function of managing a connection/bearer established by the UE 110 with the network 120 to manage a bearer ID (EPS bearer ID) and establish/maintain a bearer used to transmit and receive packets from and to the application 706. The connection management unit 702 receives an instruction from the application control unit 705 to generate a control message transmission request for a packet related to the application 706 and transmit the control message transmission request to the network 120. The context holding unit 703 holds and manages a packet filter registered, for example, with the network 120. The control message receiving unit 704 performs reception processing on a control message received after the connection management unit 702 transmits the control message transmission request. When the received control message is a control message transmitted from the network 120 based on filter information registered with the network 120 according to the control message transmission request, the control message receiving unit 704 instructs the application control unit 705 to start the application 706. Further, when the application 706 has been stopped, the application control unit 705 instructs the connection management unit 702 to transmit a control message transmission request for the packet for the application 706.

For example, it can also be said that the UE 110 for carrying out the first embodiment of the disclosed technique has a control message receiving unit for receiving, from a network, a control message indicating that there is a request message transmitted from a predetermined communication device such as the server 130 and addressed to an application on the UE 110, an application starting unit for starting an application used to process a request message when receiving the control message, a response message transmitting unit for transmitting, to the network, a response message (response to the control message) indicative of the start of the application when the application is started, a control message transmission requesting unit for transmitting, to the network upon quitting a specific application, a control message transmission request for requesting the network to transmit, to the UE 110, a control message when a network device receives a request message addressed to the application, and an identification information adding unit for adding, to the control message transmission request, identification information for identifying the request message addressed to the application.

Note that each of the functional blocks shown in FIG. 7 or each of processing units having the functions equivalent to these functional blocks may be implemented in hardware, software, or a combination thereof.

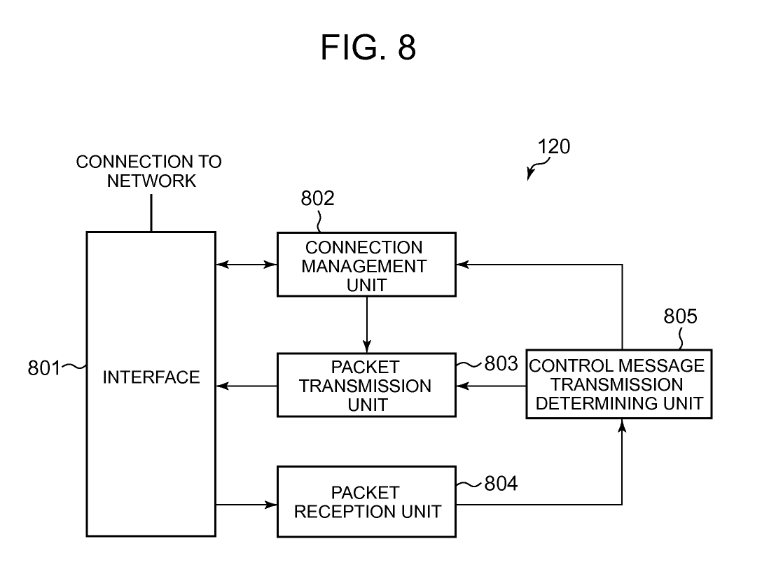

FIG. 8 is a block diagram showing an example of the configuration of the network 120 in the first embodiment of the disclosed technique. FIG. 8 schematically represents the functions of network entities that make up the network 120, and the functions may be distributed to respective network nodes. The network 120 includes an interface 801, a connection management unit 802, a packet transmission unit 803, a packet reception unit 804, and a control message transmission determining unit 805. The connection management unit 802 has the function of managing a connection/bearer established with the UE 110, which also establishes and manages a bearer used to transmit and receive packets from and to application A. The control message transmission determining unit 805 identifies filter information that matches a received packet based on held filter information when the received packet is passed from the packet reception unit 804. When a control message transmission request is included in the identified filter information, the control message transmission determining unit 805 instructs the connection management unit 802 to transmit a control message addressed to the UE 110. On the other hand, when no control message transmission request is included and the UE 110 is in the connected mode, the control message transmission determining unit 805 instructs the packet transmission unit 803 to transmit the packet using the bearer. The control message transmission determining unit 805 further maintains and manages a TFT including a packet filter (filter information) registered from the UE 110. The packet reception unit 804 receives a packet transmitted from the MTC server 130 and addressed to the UE 110, and passes the received packet to the control message transmission determining unit 805. The packet transmission unit 803 receives the instruction from the control message transmission determining unit 805 and transmits the packet using the bearer.

For example, it can also be said that the network 120 for carrying out the first embodiment of the disclosed technique has a buffer for storing a request message received from a predetermined communication device such as the server 130 and addressed to an application on the UE 110, a control message transmitting unit for transmitting, to the UE 110, a control message indicating that a request message addressed to the application on the UE 110 exists, a message forwarding unit for forwarding the buffered request message addressed to the application on the UE 110 when a response message indicating that the application is started on the UE 110 is received from the UE 110, a control message transmission request holding unit for holding a control message transmission request for requesting the transmission of a control message when receiving the request message addressed to the application on the UE 110, and a control message transmission target identifying unit for identifying the request message addressed to the application on the UE 110, for which the control message is to be transmitted, based on identification information for identifying the request message added to the control message transmission request and addressed to the application on the UE 110.

Note that each of the functional blocks shown in FIG. 8 or each of processing units having the functions equivalent to these functional blocks may be implemented in hardware, software, or a combination thereof.

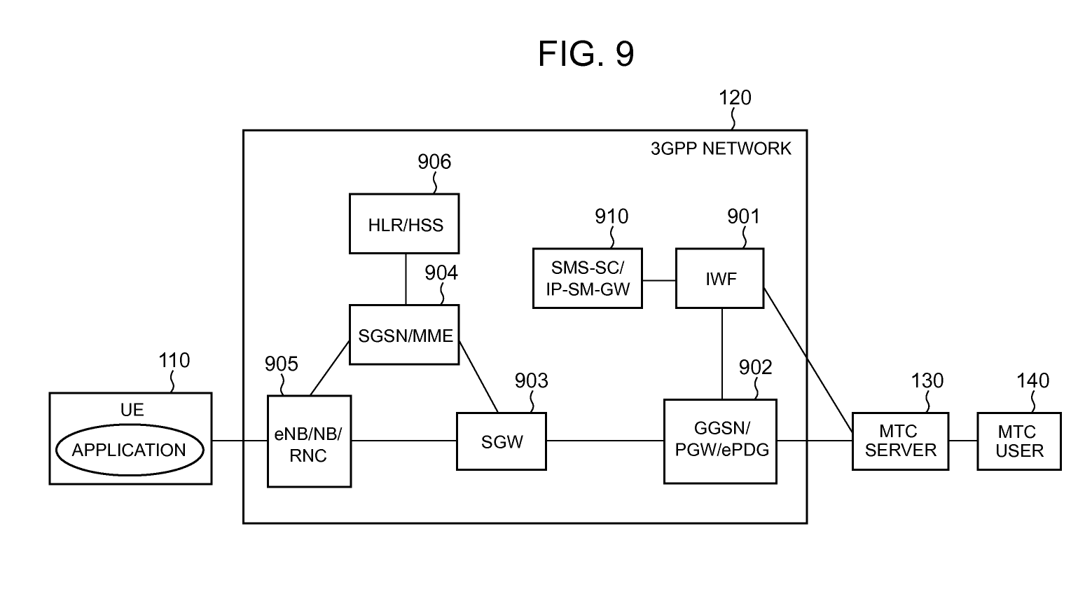

FIG. 9 is a diagram showing an example of a network configuration representing in detail entities existing within the network 120 in the first embodiment of the disclosed technique. The network 120 is made up of an IWF (Interworking Function, MTC-IWF, or proxy, also called DT-GW (Device Trigger Gateway, DT Function) 901, a PGW (Packet Data Network Gateway) (or an ePDG (evolved Packet Data Network Gateway, GGSN (GPRS Gateway Supporting Node)) 902, an SGW (Serving Gateway) 903, an SGSN (Serving GPRS Supporting Node)/MME (Mobility Management Entity) 904 (hereinafter, simply referred to as the MME 904), an eNB (eNode B or Node B, RNC (Radio Network Controller)) 905, and an HLR (Home Location Register)/HSS (Home Subscriber Server) 906. Note that the MTC server 130 may exist in the 3GPP network 120. The interface between the MTC server 130 and the IWF 901 is generally called an MTCsp interface.

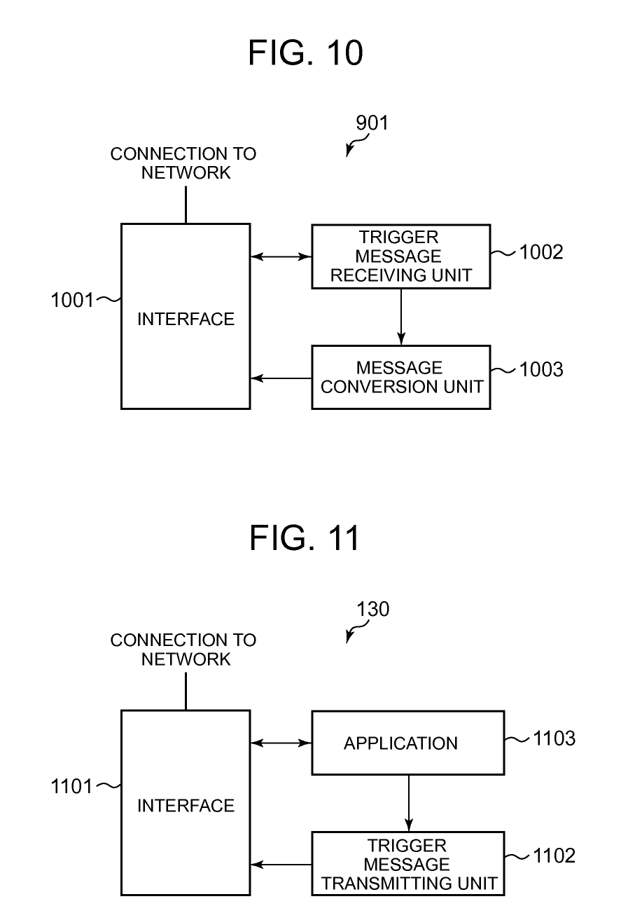

For example, a trigger message or a packet transmitted from the MTC server 130 is received by the IWF 901 or the PGW 902. FIG. 10 is a block diagram showing an example of the configuration of the IWF 901 in the first embodiment of the disclosed technique. The IWF 901 has an interface 1001 connecting to a network, a trigger message receiving unit 1002, and a message conversion unit 1003. The trigger message receiving unit 1002 receives a trigger message (C-plane packet) transmitted from the MTC server 130. The message conversion unit 1003 selects a method for triggering the UE 110 according to the trigger message received from the MTC server 130. In the case of using an established bearer, the message conversion unit 1003 is an entity for converting a C-plane trigger message to a U-plane IP packet and transmitting the U-plane IP packet. Further, when determining to transmit a control message, rather than to transmit the U-plane packet using the established bearer, the message conversion unit 1003 converts it to a control message including information in the trigger message received from the MTC server 130. For example, when determining to use SMS according to the trigger message received from the MTC server 130, the message conversion unit 1003 instructs an entity taking a role in the transmission of SMS such as SMS-SC/IP-SM-GW to transmit SMS addressed to the UE 110. As another example, when determining to use CBS, the message conversion unit 1003 instructs an entity taking a role in the transmission of a CBS message such as CBC (Cell Broadcast Center) to transmit a CBS message addressed to the UE 110.

Note that each of the functional blocks shown in FIG. 10 or each of processing units having the functions equivalent to these functional blocks may be implemented in hardware, software, or a combination thereof.

FIG. 11 is a block diagram showing an example of the configuration of the MTC server 130 in the first embodiment of the disclosed technique. The MTC server 130 has an interface 1101 connecting to a network, a trigger message transmission unit 1102, and an application 1103. The trigger message transmission unit 1102 receives an instruction on the application 1103 and transmits a trigger message (packet) addressed to the UE 110. In this regard, when the MTC server 130 knows the IP address of the UE 110, the trigger message is transmitted as a U-plane data packet addressed to the UE 110 and received by the PGW 902. On the other hand, when the MTC server 130 does not know the IF address of the UE 110, the trigger message is transmitted to the IWF 901 as a C-plane message using the ID (IMSI (International Mobile Subscriber Identity) or the URI (Uniform Resource Identifier) of the UE 110. When a message conversion function executed by the IWF 901 can be used, the C-plane message may be transmitted to the IWF 901 even if the MTC server 130 knows the IP address of the UE 110.

In this specification, messages transmitted from the MTC server 130 to the network 120 (data packets (request messages) received by the PGW 902 or C-plane messages received by the IWF 901) may be called messages addressed to an application on the user terminal.

Note that each of the functional blocks shown in FIG. 11 or each of processing units having the functions equivalent to these functional blocks may be implemented in hardware, software, or a combination thereof.

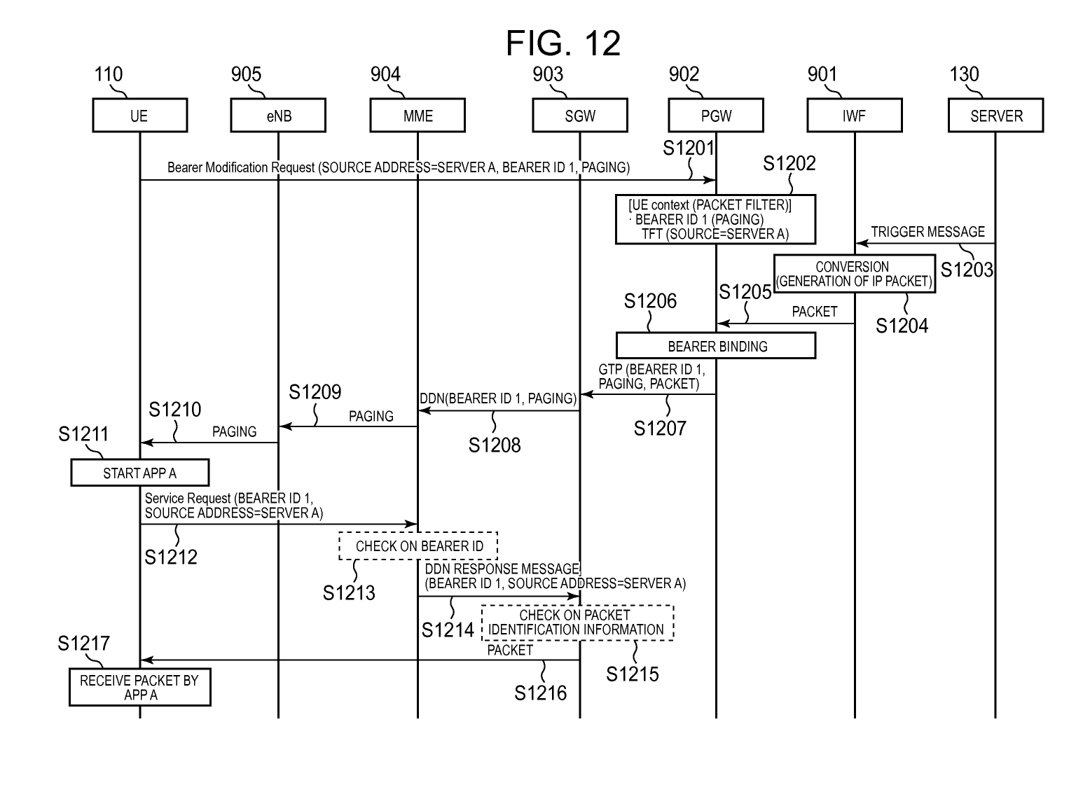

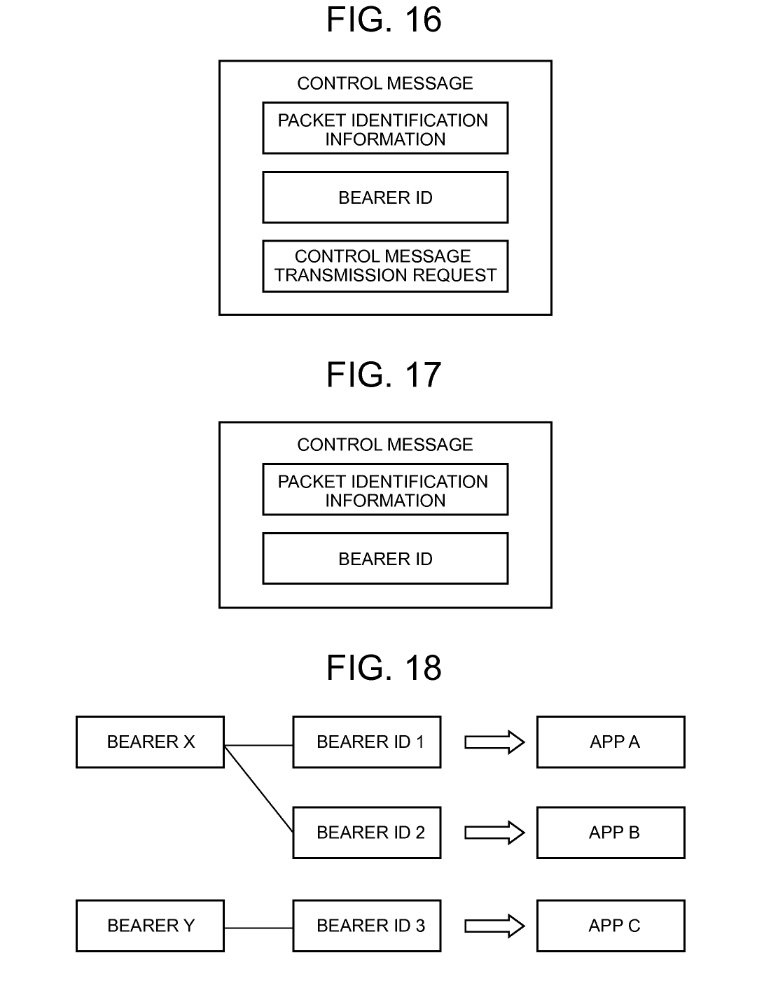

Next, an example of operation related to the first embodiment of the disclosed technique will be described based on the network configuration shown in FIG. 9. FIG. 12 is a sequence chart showing an example of transmitting a message through the IWF 901 in the first embodiment of the disclosed technique. In FIG. 12, the UE 110 transmits a Bearer Modification Request (bearer change request) message as a control message transmission request (paging transmission request) (step S1201) to request the transmission of a control message (paging) for the message from the server 130. For example, as schematically shown in FIG. 16, the Bearer Modification Request message includes a packet filter (including packet identification information) for identifying a packet from the server 130 as information to be held as a TFT (Traffic Flow Template) in the network 120, a bearer identifier (bearer ID) used to transmit the packet, and the control message transmission request (paging transmission request). The Bearer Modification Request message is received by the PGW 902 in the network 120, and the PGW 902 holds information included in the message as the TFT (step S1202). For example, the TFT held by the PGW 902 indicates that, when a packet that matches the bearer identifier (bearer ID 1) used to transmit the packet and packet identification information (indicating that the source address of the packet is the address of server A) is received, a control message (paging) is transmitted.

It is assumed that the MTC server 130 transmits, to the UE 110, a packet related to application A. Assuming here that the MTC server 130 does not know the IP address of the UE 110, the MTC server 130 transmits a trigger message including the ID of the UE 110 to the IWF 901 (step S1203). The IWF 901 generates an IP packet based on the trigger message received (step S1204). Specifically, the IWF 901 converts the received message to an IP packet in which the IP address of the UE 110 identified by the ID in the message is set as the destination address, and forwards the IP packet to the PGW 902 (step S1205).

For example, in the case of use of the GTP (GPRS Tunneling Protocol) protocol as an interface (S5/S8) between the PGW 902 and the SGW 903, when receiving a packet addressed to the UE 110 from the IWF 901, the PGW 902 searches for a packet filter corresponding to the packet, adds a paging request to the packet according to the paging request included in the packet filter (step S1206), and forwards, to the SGW 903, the packet with the paging request added thereto (step S1207). In this regard, it is desired to add the paging request into the GTP header of a GTP message including the packet.

When receiving the GTP message with the paging request added is received, the SGW 903 transmits a DDN (DownLink Data Notification) message to the MME 904 even when the UE 110 is in the connected mode (step S1208). In other words, when the paging request is added, the SGW 903 instructs the MME 904 to transmit paging instead of forwarding the packet to the eNB 905 even if the SGW 903 holds information on the eNB 905 to which the UE 110 is being connected. Note that the SGW 903 can figure out the operating mode (connected mode or idle mode) of the UE 110.

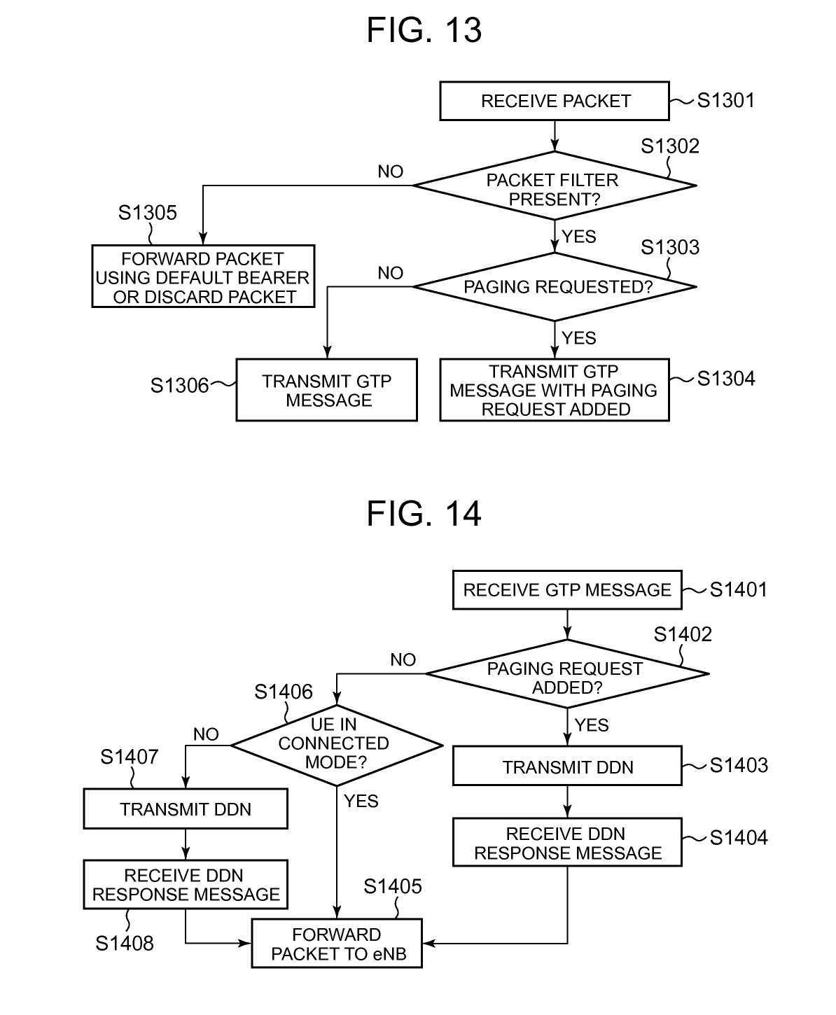

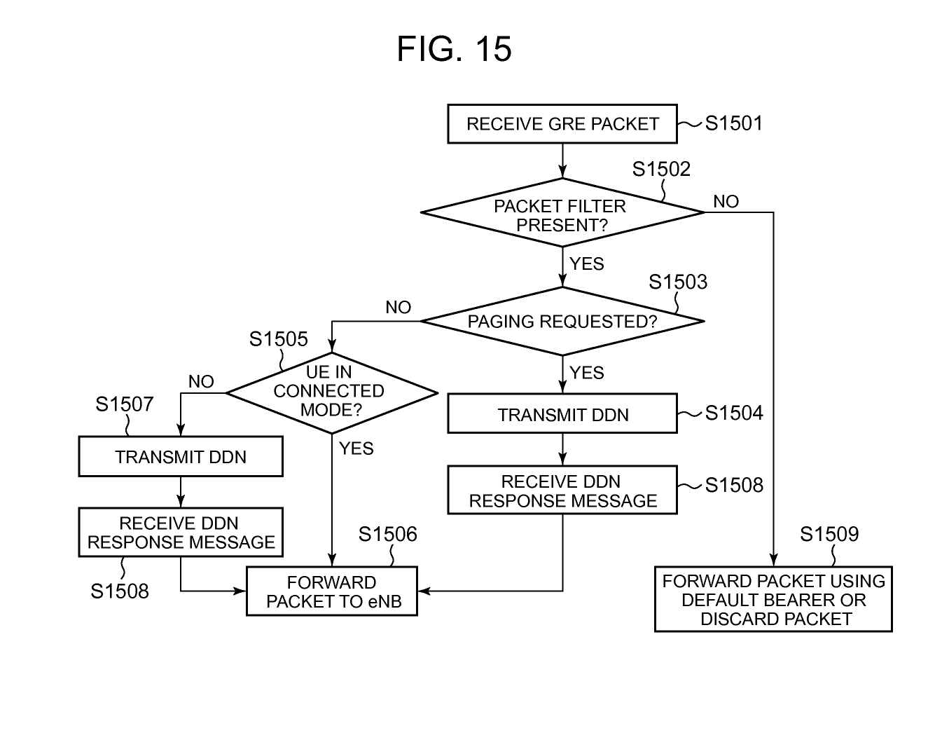

In FIG. 12, the case where the GTP protocol is used as the interface (S5/S8) between the PGW and the SGW is shown. However, in the case of use of the PMIP (Proxy Mobile IP) protocol as the interface (S5/S8) between the PGW and the SGW, when receiving a packet addressed to the UE 110 from the IWF 901, the PGW 902 adds a GRE (Generic Routing Encapsulation) header to the packet and forwards the packet to the SGW 903. An example of the operation of the PGW 902 and the SGW 903 when the GTP protocol is used will be described later with reference to FIG. 13 and FIG. 14, and an example of the operation of the SGW 903 when the PMIP protocol is used will be described later with reference to FIG. 15, respectively.

When receiving a DDN from the SGW 903, the MME 904 transmits a paging message to the eNB 905 (step S1209), and the eNB 905 that received the paging message transmits paging addressed to the UE 110 (step S1210). When the MME 904 treats, as an error, the DDN message for the UE 110 in the connected mode, it is desired that the SGW 903 should add a paging request into the DDN message to instruct the MME 904 to transmit paging. This allows the MME 904 to recognize that the transmission of the paging message for the UE 110 in the connected mode is required.

As described in FIG. 6, when the UE 110 is in the connected mode, the UE 110 that received the paging message from the eNB 905 starts application A (step S1211) and transmits a service request message as a paging response (step S1212). The MME 904 that received the service request message transmits a DON response message to the SGW 903 (step S1214). Then, the SGW 903 that received the DON response message forwards the buffered packet to the UE 110 (step S1216). Since the UE 110 already runs application A, the forwarded packet can be received (step S1217). As the DON response message, a Modify Bearer Request message can be used.

For example, as schematically shown in FIG. 17, the UE 110 may include, in the service request message, the bearer ID of a bearer used for transmission and reception of packets for running application A and/or packet identification information. In this case, when the bearer ID in the message matches the bearer ID received from the SGW 903, the MME 904 that received the service request message can recognize that the service request message is a message transmitted from the UE 110 in the connected mode that has started the application for transmitting and receiving packets using a bearer identified by the bearer ID. When receiving the service request message including the bearer ID, the MME 904 may check on the bearer ID (step S1213) to determine whether to transmit the DON response message to the SGW 903.

Further, when packet identification information (e.g., the address of the server 130) included in the DON response message matches packet information (e.g., the source address of the packet) included in the GTP message received from the PGW 902, the SGW 903 that received the DON response message from the MME 904 can recognize that the DON response message is transmitted based on the message transmitted from the UE 110 that has started corresponding application A. When receiving the DON response message including packet identification information, the SGW 903 may check on the packet identification information (step S1215) to determine whether to forward the packet to the UE 110.

FIG. 13 is a flowchart showing an example of processing performed by the PGW 902 when the GTP protocol is used in the first embodiment of the disclosed technique. The processing in FIG. 13 corresponds to the processing performed by the PGW 902 in step S1206 of FIG. 12. In the case of use of the GTP (GPRS Tunneling Protocol) protocol as the interface (S5/S8) between the PGW 902 and the SGW 903, when receiving a packet addressed to the UE 110 from the IWF 901 or the server 130 as shown in FIG. 13 (step S1301), the PGW 902 searches for a packet filter corresponding to the packet (step S1302). When the corresponding packet filter is found, the PGW 902 checks whether a paging request is included in the packet filter (step S1303). When the paging request is included in the packet filter, the PGW 902 adds the paging request to the packet and forwards the packet to the SGW 903 (step S1304). In this regard, it is desired to add the paging request into the GTP header of a GTP message including the packet. When it is checked in step S1303 that no paging request is included in the packet filter, the PGW 902 transmits the GTP message including the packet without adding any paging request (step S1306). When no packet filter is found in step S1302, the packet is transmitted using the default bearer or the packet is discarded (step S1305).

FIG. 14 is a flowchart showing an example of processing performed by the SGW 903 when the GTP protocol is used in the first embodiment of the disclosed technique. The processing in FIG. 14 corresponds to the processing performed by the SGW 903 after receiving the GTP message in step S1207 of FIG. 12. In FIG. 14, when receiving the GTP message from the PGW 902 (step S1401), the SGW 903 checks whether a paging request is added to the GTP message (step S1402). When the paging request is added to the GTP message received from the PGW 902, the SGW 903 transmits a DDN (Down Link Data Notification) message to the MME 904 even if the UE 110 is in the connected mode (step S1403). In other words, even if the SGW 903 holds information on the eNB 905 to which the UE 110 is being connected, when the paging request is added, the SGW 903 instructs the MME 904 to transmit paging instead of forwarding the packet to the eNB 905. In this case, when receiving the paging, the UE 110 starts the application and transmits a DDN response message. After waiting for and receiving the DDN response message from the UE 110 (step S1404), the SGW 903 forwards the packet to the eNB 905 (step S1405).

On the other hand, when no paging request is added to the GTP message received from the PGW 902, the SGW 903 checks whether the UE 110 is in the connected mode (step S1406). When the UE 110 is in the connected mode, the SGW 903 forwards the packet to the eNB 905 (step S1405). On the other hand, when the UE 110 is in the idle mode, the SGW 903 transmits the DDN message to the MME 904 (step S1407), and forwards the packet to the eNB 905 (step S1405) after waiting for and receiving the DDN response message (step S1408). In this case, the UE 110 changes its state from the idle mode to the connected mode when receiving the paging, and starts the application to transmit the DDN response message.

FIG. 15 is a flowchart showing an example of processing performed by the SGW when the PMIP protocol is used in the first embodiment of the disclosed technique. The processing in FIG. 15 corresponds to the processing performed by the SGW 903 after receiving a GRE packet rather than the GTP message in step S1207 of FIG. 12. In the case of use of the PMIP (Proxy Mobile IP) protocol as the interface (S5/S8) between the PGW 902 and the SGW 903, when receiving a packet addressed to the UE 110 from the IWF 901 or the server 130, the PGW 902 adds a GRE header to the packet and forwards the packet to the SGW 903. When receiving, from the PGW 902, an encapsulated packet (GRE packet) to which the GRE header is added (step S1501), the SGW 903 searches for a packet filter corresponding to the packet received (step S1502), and checks whether a paging request is added into the packet filter found (step S1503). When the paging request is added, the SGW 903 transmits a DDN message to the MME 904 (step S1504). In other words, even if the SGW 903 holds information on the eNB 905 to which the UE 110 is being connected, when the paging request is added into the packet filter, the SGW 903 instructs the MME 904 to transmit paging instead of forwarding the packet to the eNB 905.

On the other hand, when no paging request is added into the packet filter, the SGW 903 checks whether the UE 110 is in the connected mode (step S1505). When the UE 110 is in the connected mode, the SGW 903 forwards the packet to the eNB 905 as usual (step S1506). On the other hand, when the UE 110 is in the idle mode, the SGW 903 transmits a DDN message to the MME 904 (step S1507), and forwards the packet to the eNB 905 (step S1506) after waiting for and receiving a DDN response message (step S1508). In this case, the UE 110 changes its state from the idle mode to the connected mode when receiving the paging, and starts the application to transmit the DDN response message. When no packet filter is found in step S1502, the packet is transmitted using the default bearer or the packet is discarded (step S1509).

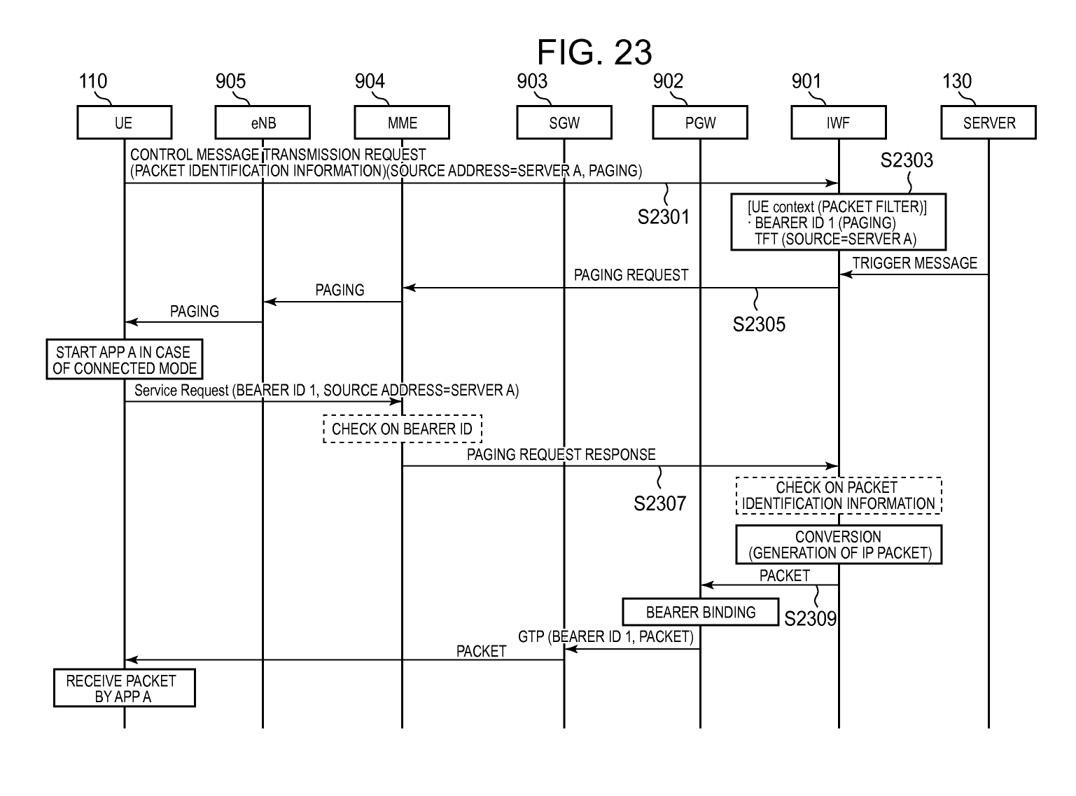

FIG. 23 is a sequence chart showing an example when the IWF 901 directly instructs the MME 904 to transmit paging in the first embodiment of the disclosed technique. The following description will be made mainly about points different from the sequence chart shown in FIG. 12 mentioned above to omit the description of the same or similar operations.

As shown in FIG. 23, it is possible for the UE 110 to transmit a control message transmission request to the IWF 901 (step S2301). In this case, when the IWF 901 holds the packet filter of the UE 110 (step S2303), and when a trigger message received from the server 130 is a packet corresponding to the packet filter held, the IWF 901 buffers the trigger message and instructs the MME 904 to transmit paging addressed to the UE 110 (step S2305). Then, when the UE 110 starts the application in response to receiving the paging and returns a response message, the MME 904 transmits a paging request response to the IWF (step S2307). When receiving the paging request response from the MME 904, the IWF 901 converts the buffered trigger message received from the server 130 to a packet addressed to the UE 110 and transmits the packet (step S2309). The packet is forwarded to the UE 110 through the established connection/bearer. The IWF 901 may transmit the trigger message received from the server 130 as SMS addressed to the UE 110.

The UE 110 may transmit the paging request response to the server 130. In this case, the server 130 transmits a packet for application A to the UE 110 after receiving the paging request response from the UE 110. In this case, the IWF 901 may omit the buffering of the trigger message received from the server 130. Further, the UE 110 that received the paging and has started the application may wait for the reception of the packet without returning the paging request response. In this case, the IWF 901 or the server 130 forwards the packet addressed to the UE 110 after a predetermined period has elapsed.

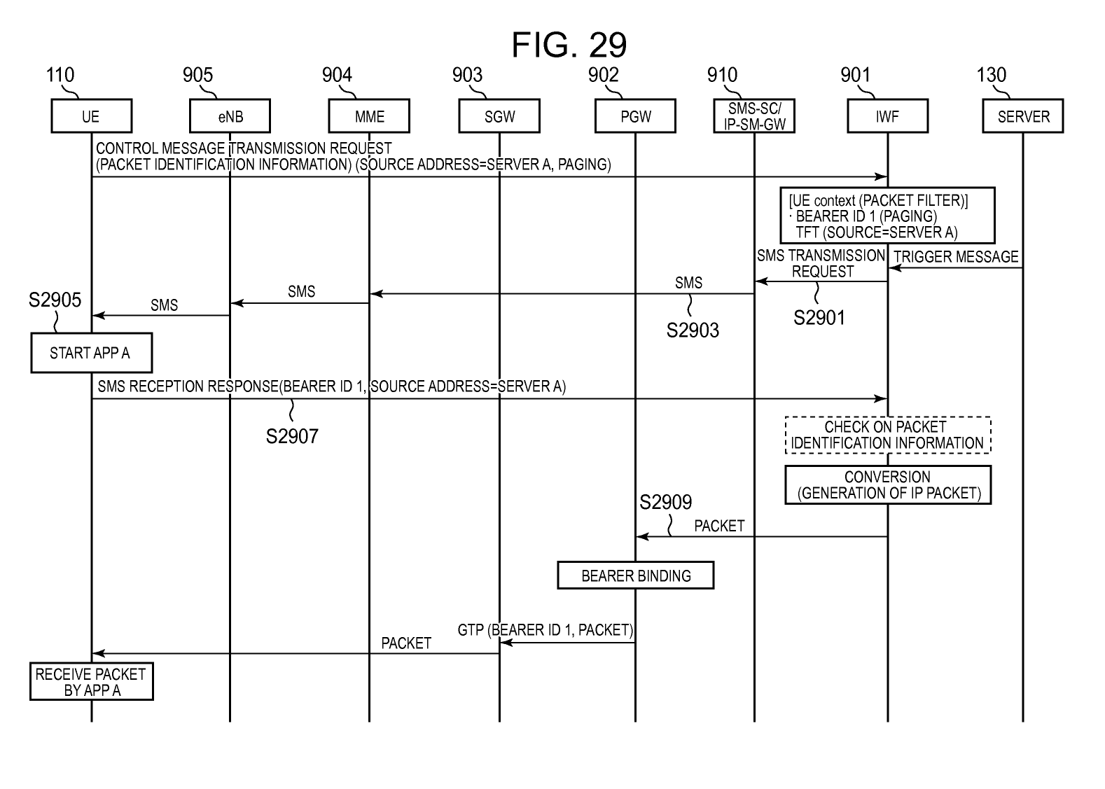

FIG. 29 is a sequence chart showing an example when the IWF 901 instructs the SMS-SC (SMS Service Center)/IP-SM-GW (IP Short Message Gateway) to transmit SMS as the control message in the first embodiment of the disclosed technique. The following description will be made mainly about points different from the sequence chart shown in FIG. 23 mentioned above to omit the description of the same or similar operations.

As shown in FIG. 29, when the IWF 901 holds the packet filter of the UE 110 and a trigger message received from the server 130 is a packet corresponding to the packet filter held, the IWF 901 buffers the trigger message and instructs the SMS-SC/IP-SM-GW 910 to transmit SMS addressed to the UE 110 (step S2901). Then, the SMS-SC/IP-SM-GW 910 transmits the SMS to the UE 110 (step S2903), and the UE 110 starts the application in response to receiving the SMS (step S2905). The UE 110 that started the application returns an SMS reception response to the IWF 901 (step S2907). When receiving the SMS reception response from the UE 110, the IWF 901 converts the buffered trigger message received from the server 130 to a packet addressed to the UE 110 and transmits the packet (step S2909). The packet is forwarded to the UE 110 through the established connection/bearer. The UE 110 may transmit the SMS reception response to the server 130. In this case, after receiving the SMS reception response from the UE 110, the server 130 transmits a packet for application A to the UE 110. Further, in this case, the IWF 901 may omit the buffering of the trigger message received from the server 130. The UE 110 that received the SMS and has started the application may wait for the reception of a packet without returning the SMS reception response. In this case, the IWF 901 or the server 130 forwards the packet to the UE 110 after a predetermined period has elapsed.

The UE 110 may transmit, to the PGW 902 or the IWF 901, a control message transmission request with a specific control message such as paging, SMS, or CBS specified therein, or transmit a control message transmission request with no control message particularly specified. In the latter case, when receiving a packet from the server 130, the PGW 902 or the IWF 901 determines which control message is used to trigger the UE 110.

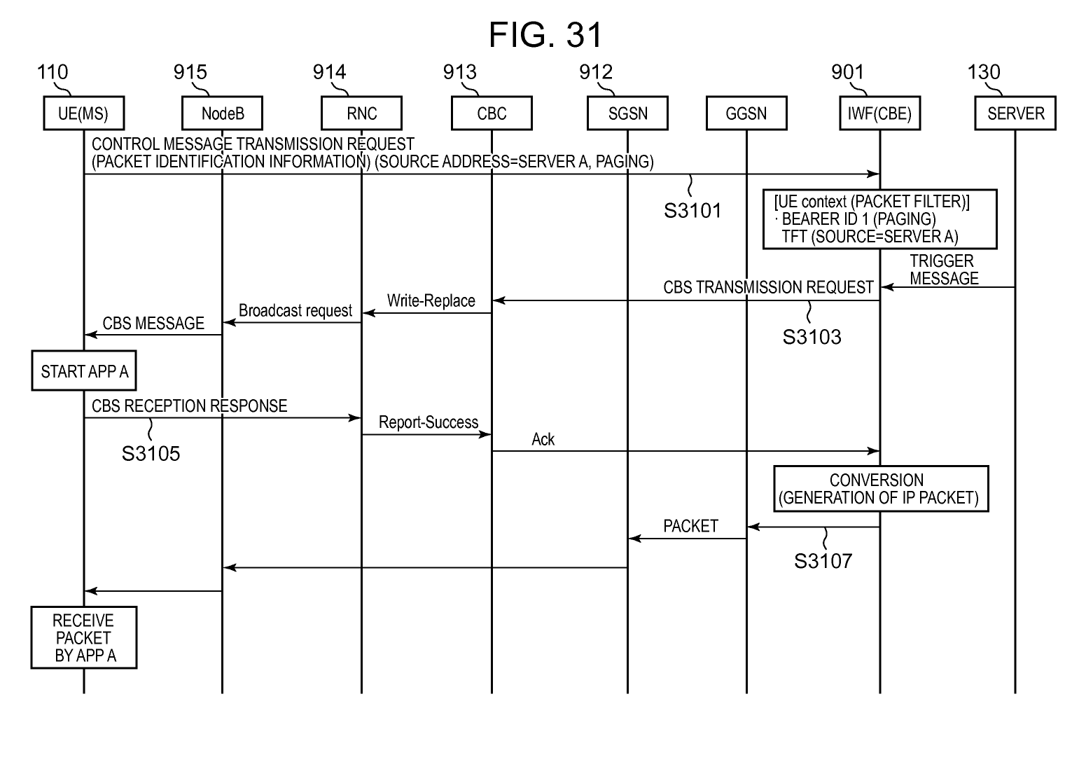

FIG. 31 is a sequence chart showing an example when the IWF 901 instructs a CBC 913 to transmit a CBS message (broadcast message) as the control message in the first embodiment of the disclosed technique. The following description will be made mainly about points different from the sequence chart shown in FIG. 23 mentioned above to omit the description of the same or similar operations.

When receiving a trigger message from the server 130, the UE 110 requests the IWF 901 to transmit a CBS message addressed to the UE 110 (step S3101). When receiving the trigger message addressed to the UE 110 from the server 130, if the received trigger message corresponds to a trigger message in which the IWF 901 is requested from the UE 110 to transmit the CBS message, the IWF 901 requests the network to transmit the CBS message (broadcast message) (step S3103). When the trigger message received from the server 130 includes information to be notified to the UE 110 (e.g., information for identifying the ID of an application to be started or a message, and information on the connection to be established, such as APN, the URI of the server, or the IP address), the IWF 901 may instruct the network to include these pieces of information in the CBS message. As a specific method of transmitting the CBS message, the IWF 901 as CBE (Cell Broadcast Entity) requests the CBC (Cell Broadcast Center) 913 to transmit a CBS message addressed to the UE 110, and the CBC 913 transmits the CBS message to the UE 110 through an RNC 914 and a NodeB 915. The IWF 901 may include, in the CBS message to be transmitted, only the ID of the UE 110 as an ID for identifying the UE to receive or the ID of a group to which the UE 110 belongs.

When the server 130 transmits a trigger message to two or more UEs belonging to a certain group, the use of a CBS message instead of paging reduces the number of messages transmitted from the network into only one broadcast message. Therefore, there is no need to transmit two or more paging or SMS messages, and the effect of reducing the load on the network can be obtained.

When receiving the CBS message addressed to itself, the UE 110 starts application A and returns a CBS message reception response to the IWF 901 (step S3105). The IWF 901 that received the CBS message reception response transmits, to the UE 110, a packet generated based on the trigger message received from the server 130 (step S3107). As a specific example of a method of returning the reception response to the IWF 901, the UE 110 transmits the CBS reception response to the RNC 914 (eNodeB in LTE/SAE). When the RNC 914 that received the CBS reception response transmits Report-Success to the CBC 913, Ack is transmitted from the CBC 913 to the IWF 901. As another example, the UE 110 may transmit the CBS reception response to an SGSN 912 (MME in LTE/SAE) and the SGSN 912 may transmit Ack to the IWF 901. In this case, a Service request can be used as the message to be transmitted to the SGSN 912. In the Service request, information (Information Element) for notifying the SGSN 912 that the message is the CBS reception response may be included.

When receiving Ack indicating that the UE 110 has attached to the network in response to receiving the CBS message, the IWF 901 generates an IP packet based on the trigger message received from the server 130, and transmits the IP packet to the UE 110. Thus, since the UE 110 can receive packets addressed to application A in the state of running application A, the need for buffering required when a packet is received before starting the application is also eliminated.

The technique described in the first embodiment of the disclosed technique is also effective in requesting the UE 110 to attach to the network and/or to establish a new connection.

For example, when the server 130 transmits, to the IWF 901, the trigger message addressed to the UE 110 to communicate with the UE 110, if it is determined that an appropriate connection to the network where the UE 110 and the server 130 reside has not been established yet, a control message transmission request is added to the trigger message. This includes a case where it is determined that, even when the UE 110 has an established connection, the connection is not suited to forward the trigger message as a data packet, or a case where it is determined that the connection is not suited to forward data in communication to be started from now. The term “not suited” means, for example, a case where the APN (Access Point Name) of the existing connection is different from an APN in the communication to be newly started, or a case where the QoS (Quality of Service) of the existing connection does not fit the new communication.

Thus, the IWF 901 forwards the trigger message using a control message according to the control message transmission request included in the trigger message addressed to the UE 110 and received from the server 130 so that the IWF 901 can instruct the UE 110 to establish a connection usable to forward a data packet in the communication.

When notified from the network that the UE 110 has responded to the control message, the IWF 901 may forward the notification to the server 130. In this case, the server 130 that received the notification of the response of the UE 110 transmits a packet to the UE 110, rather than that the IWF 901 forwards, to the UE 110, a packet generated based on the trigger message. In other words, the server 130 transmits a trigger message to request the UE 110 to start application A or the UE 110 to attach to the network and establish a connection. As a result, after receiving the notification that the UE 110 has responded to the control message (i.e., the UE 110 has started application A, or has attached to the network and established a connection in response to receiving the control message), the IWF 901 transmits a data packet to the UE 110. Thus, the load on the network or the IWF 901 to generate or buffer packets can be reduced.

The server 130 may also include, in the trigger message to transmit to the IWF 901, information indicating that this trigger message is a trigger message for requesting the UE 110 to start application A, or to attach to the network and establish a connection. In other words, when the information mentioned above is included in the trigger message, the IWF 901 can recognize that there is no need to transmit, to the UE 110, the packet generated based on the trigger message.

The technique described in the first embodiment of the disclosed technique is also effective in a case where it is not suited to transmit downlink data (Mobile Terminated Data) to the UE 110 in order to request the UE 110 not only to start an application on the UE 110 but also to transmit data (Mobile Originated Data).

For example, when an application running on the UE 110 does not respond to the reception of downlink data, the technique described in the first embodiment of the disclosed technique can be used. When the application does not respond to the reception of downlink packets, data packets sent from the server 130, a node within the cellular network, and any other UE 110 end up being discarded by the PGW 902 or the UE 110. For example, when no bearer is associated with a packet for the application in a TFT held by the PGW 902, the PGW 902 discards the packet without forwarding the packet. As other cases where the technique described in the first embodiment of the disclosed technique can be used, there are cases where downlink data is used to instruct the UE 110 to transmit data and where two or more UEs 110 are instructed at the same time. In these cases, since the amount of data traffic increases, it is desired to instruct the UE 110 to transmit data without using downlink data or to receive such an instruction. In such a case, this technique can be used.

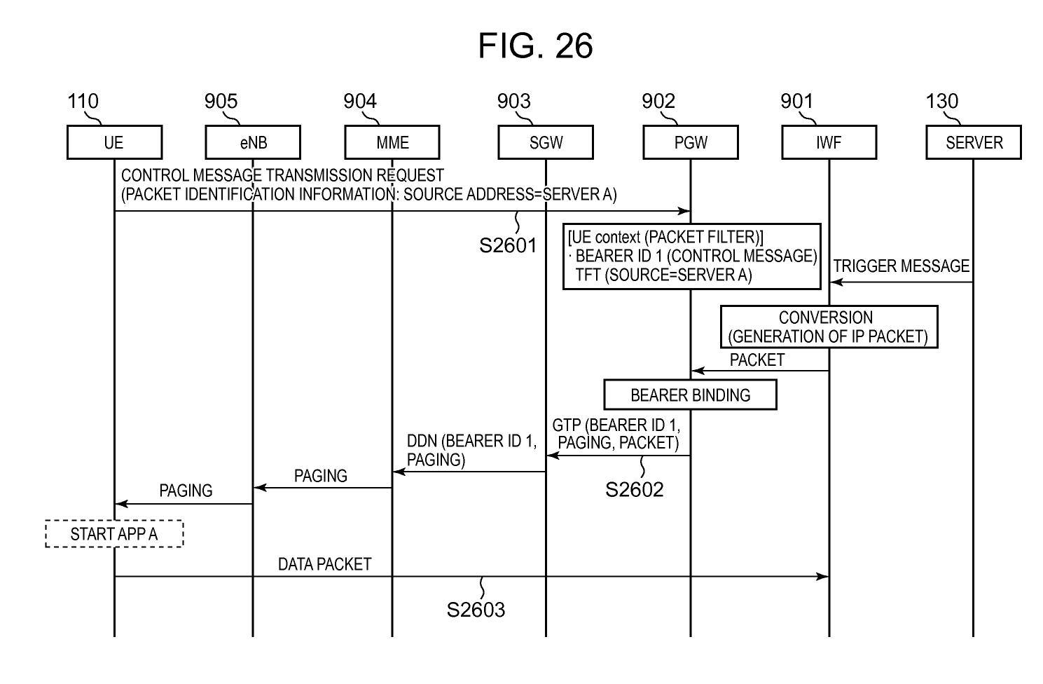

FIG. 26 is a sequence chart showing an example when paging is used as the control message to trigger data transmission from the UE 110 in the first embodiment of the disclosed technique. The following description will be made mainly about points different from the sequence chart shown in FIG. 12 mentioned above to omit the description of the same or similar operations. In the above case, when receiving a packet related to an application that is not suited to receive downlink data, the UE 110 transmits, to the PGW 902, a control message transmission request for requesting the transmission of a control message (step S2601). The PGW 902 forwards, to the SGW 903, a GTP packet generated based on the packet received from the IWF 901 (step S2602). This GTP packet is to request the transmission of DON related to the UE 110, rather than to forward, to the SGW 903, the packet addressed to the UE. Therefore, the SGW 903 transmits the DDN to the MME 904 in response to the GTP packet from the PGW 902 without forwarding the packet to the UE 110. Then, when receiving paging, the application on the UE 110 is triggered by this paging to start the transmission of data to the server 130, a node within the cellular network, or any other UE 110 (step S2603). When the application is not started upon receiving the paging, the UE 110 starts the transmission of data after starting the application. As another operation of the UE 110 upon receiving the paging, the UE 110 may establish a new connection to the network.

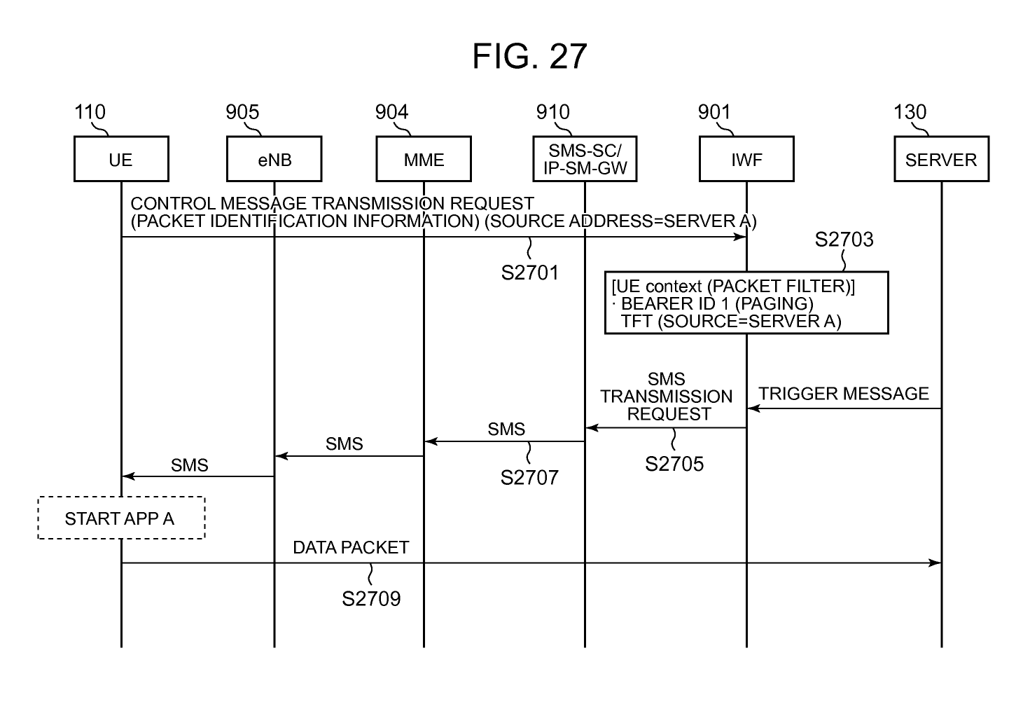

FIG. 27 is a sequence chart showing an example when SMS is used as the control message to trigger data transmission from the UE 110 in the first embodiment of the disclosed technique. The UE 110 transmits, to the IWF 901, a control message transmission request for requesting the transmission of a control message (SMS here) (step S2701), and the packet filter is registered with the IWF 901 (step S2703). When receiving the trigger message from the server 130, the IWF 901 determines the use of SMS as the control message and requests the SMS-SC/IP-SM-GW 910 to transmit the SMS (step S2705). Thus, for example, the SMS-SC/IP-SM-GW 910 transmits the SMS to the UE 110 (step S2707).

The application on the UE 110 that received the SMS is triggered by this received SMS to start data transmission to the server 130, a node within the cellular network, or any other UE 110 (step S2709). When the application is not started upon receiving the SMS, the UE 110 starts data transmission after starting the application. Further, when the trigger message received from the server 130 includes information to be notified to the UE 110 (e.g., information for identifying an application to be started or a message, and information on the connection to be established, such as APN, the URI of the server, or the IP address), the IWF 901 may include the information in the SMS message. Further, a message to be transmitted immediately after app A is started may be preset in app A. Thus, since data transmission from the UE 110 can be requested without using downlink data, an increase in the amount of data traffic can be prevented. Even if the IP address of the UE 110 that the server 130 knows has been changed, data transmission from the UE 110 can also be triggered. As another operation of the UE 110 upon receiving the SMS, a new connection to the network may be established using information included in the SMS and required to establish the connection.

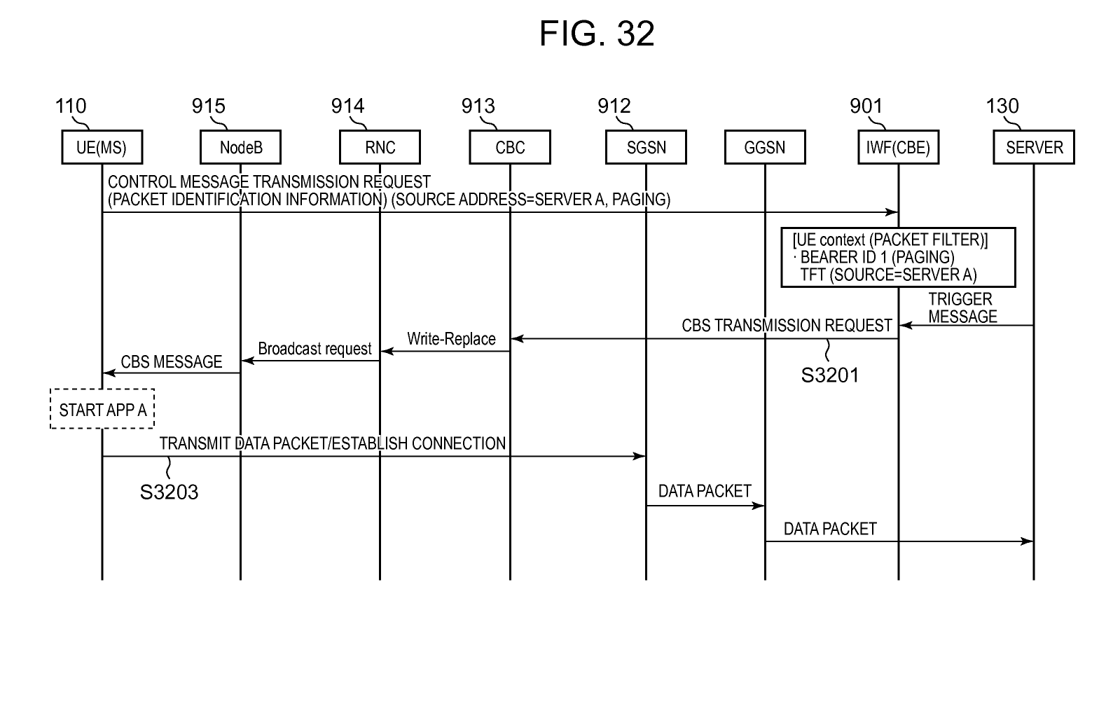

FIG. 32 is a sequence chart showing an example when CBS is used as the control message to trigger data transmission from the UE 110 in the first embodiment of the disclosed technique. When receiving a trigger message addressed to the UE 110 from the server 130, if the received trigger message corresponds to a trigger message in which the IWF 901 is requested from the UE 110 to transmit a CBS message, the IWF 901 will request the network to transmit the CBS message (broadcast message) (step S3201). When the trigger message received from the server 130 includes information to be notified to the UE 110 (e.g., information for identifying an application to be started or a message, and information on the connection to be established, such as APN, the URI of the server, or the IP address), the IWF 901 may instruct the network to include these pieces of information in the CBS message. As a specific example of a method of transmitting the CBS message, the IWF 901 as CBE (Cell Broadcast Entity) requests the CBC (Cell Broadcast Center) 913 to transmit the CBS message addressed to the UE 110, and the CBC 913 transmits the CBS message to the UE 110 through the RNC 914 and the NodeB 915. The IWF 901 may include, in the CBS message to be transmitted, only the ID of the UE 110 as an ID for identifying the UE to receive or the ID of a group to which the UE 110 belongs.

The UE 110 that received the CBS message starts application A and transmits, to the server 130, a data packet through application A (step S3203). A message to be transmitted immediately after application A is started may be preset in application A. As another operation of the UE 110 upon receiving the CBS, a new connection to the network may be established using information included in the CBS and required to establish the connection.

A node for managing information on the UE 110 may be provided within the 3GPP network 120 so that the UE 110 will register filter information with the node. In this case, the PGW 902 or the IWF 901 may make an inquiry to the node managing the information on the UE 110 to determine whether to transmit a control message to the UE 110.

As described above, according to the first embodiment of the disclosed technique, since the UE 110 can receive a control message indicative of a packet reception notification before a packet addressed to an application that is not running is received, the UE 110 can receive the packet using the reception of the control message as a trigger after starting the application. Thus, power consumption and memory consumption due to the CPU power and CPU operation for keeping the application always running can be reduced.

### Second Embodiment

Next, the second embodiment of the disclosed technique will be described. In the second embodiment of the disclosed technique, description will be made of a method for enabling a UE 110 holding two or more applications to determine which application is to be started when receiving a control message.

FIG. 18 is a diagram showing an example of bearer IDs assigned to bearers established between the UE 110 and the network 120 in the second embodiment of the disclosed technique. Under normal conditions, only one ID is assigned to one bearer, but the UE 110 in the second embodiment requests the assignment of a bearer ID per application. For example, when there are two applications using bearer X, bearer ID 1 is assigned to application A and bearer ID 2 is assigned to application B. Further, bearer ID 3 is assigned to application C using bearer Y. Thus, a specific application corresponding to a bearer ID can be identified based on the bearer ID. Note that a bearer ID may be generated using an application ID assigned to each application. In this case, the use of a bearer ID is equivalent to the use of an application ID.

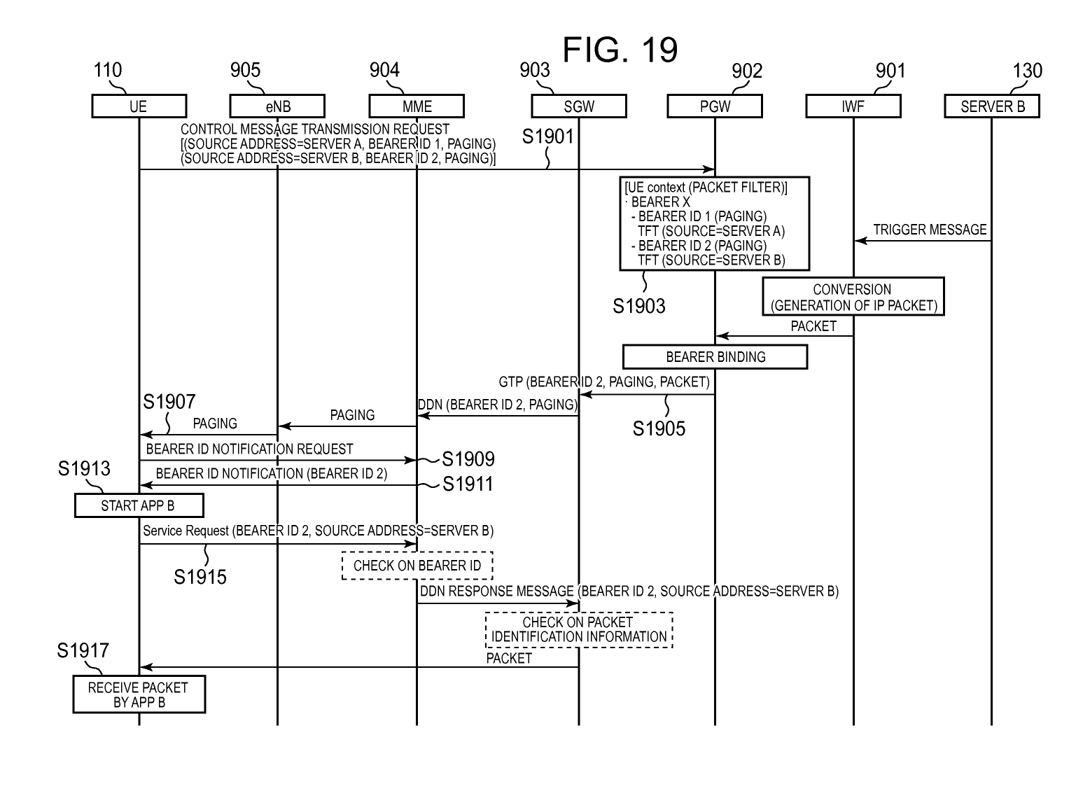

FIG. 19 is a sequence chart showing an example of processing in which a message for application B is received from server B when control message transmission requests related to application A and application B are registered in the second embodiment of the disclosed technique. The following description will be made mainly about operations different from the first embodiment of the disclosed technique (points different from the sequence chart shown in FIG. 12) to omit the description of the same or similar operations as or to those in the first embodiment of the disclosed technique.

The UE 110 can register packet filters corresponding to two or more bearer Ds by making a control message transmission request. Here, for example, it is assumed that a control message transmission request including packet identification information (the address of server A) and a paging transmission request for bearer ID 1, and packet identification information (the address of server B) and a paging transmission request for bearer ID 2 is transmitted to the PGW 902 (step S1901). This causes the PGW 902 to hold, as a TFT, information on bearer ID 1 and information on bearer ID 2 in the context of bearer X (step S1903). For example, when receiving a packet from the server B 130 or the IWF 901, the PGW 902 adds a paging request to the packet addressed to the UE 110 from the server B 130 based on the TFT, and transmits the packet to the SGW 903 (step S1905). As a result, like in the first embodiment of the disclosed technique mentioned above, the UE 110 receives paging indicative of a packet reception notification even in the connected state (step S1907).

When receiving the paging, the UE 110 understands that there is a need to start an application, but cannot identify which application is to be started (either of applications A and B in this case). Therefore, when receiving the paging, the UE 110 transmits a message for requesting the notification of a bearer ID (step S1909), and receives a notification of bearer ID 2 as a response (step S1911). As a result, since the UE 110 learns that bearer ID 2 is an ID assigned to application B based on the relationship shown in FIG. 18, the UE 110 starts application B (step S1913) and returns a service request (step S1915). As a result, the UE 110 can receive the buffered packet by application B.

As another method for the UE 110 to start a correct application, the UE 110 may start the most likely application based on the time at which the paging is received and the timing to respond to the paging by including the bearer ID of the started application in the service request. In this case, the UE 110 estimates and starts the most likely application without making an inquiry about the bearer ID, and transmits the service request. Like the MME 904 in the first embodiment of the disclosed technique, when the bearer ID in the service request matches the bearer ID in a DDN message received from the SGW 903, the MME 904 determines that the UE 110 runs a correct application and returns a DON response message to the SGW 903. On the other hand, when the bearer IDs are different, the MME 904 transmits, to the UE 110, a response (including the bearer ID assigned to an application to be started) to the service request in order to request the UE 110 to start a different application.

As still another method, when receiving the paging message, the UE 110 may start all applications registered as targets of a control message notification request (here, both of applications A and B) to return a paging response. Thus, even when a packet for either application A or application B is forwarded, the UE 110 can receive the packet.

As another method for the UE 110 to learn the bearer ID, the bearer ID may be included in the paging message transmitted from the MME 904 and the eNB 905. This allows the UE 110 to learn the bearer ID immediately when receiving the paging and hence to start an appropriate application. As still another method, when SMS is used as the control message to trigger the UE 110 as described with reference to FIG. 29 in the first embodiment of the disclosed technique, the bearer ID and/or the application ID may be included in the SMS and transmitted to the UE 110. In this case, the IWF 901 includes the bearer ID and/or the application ID in an SMS transmission request to be transmitted to the SMS-SC/IP-SM-GW 910, and transmits the SMS transmission request. Thus, when receiving the SMS, the UE 110 can identify an application to be started to run an appropriate application. On the other hand, when notification information (SIB) is used as the control message to trigger the UE 110, the bearer ID and/or the application ID may be included in a corresponding SIB.

As described above, according to the second embodiment of the disclosed technique, even when there are two or more applications to be started, the UE 110 can start an application required to receive a packet. Particularly, since each application is associated with a bearer ID, an application to be started can be determined based on the bearer ID from among the two or more applications.

For example, it can also be said that the UE 110 for carrying out the second embodiment of the disclosed technique has, in addition to the configuration of the first embodiment, an application information requesting unit for requesting, from the network, information for identifying an application used to process a request message addressed to the application, an application information receiving unit for receiving, from the network, the information for identifying an application used to process a request message addressed to the application, an application estimation unit for estimating an application used to process a request message addressed to the application when receiving a control message, and starting the estimated application, an application notification unit for notifying the network of information indicative of the estimated application, and an application information receiving unit for receiving, from the network, information for identifying an application used to process a request message addressed to the application when the estimated application is not appropriate as the application used to process the request message addressed to the application.

Further, for example, it can be said that the network 120 (network device) for carrying out the second embodiment of the disclosed technique has, in addition to the configuration of the first embodiment, an information transmission unit for transmitting, upon request of the UE 110, information for identifying an application used to process a request message addressed to the application on the UE 110, an application information receiving unit for receiving information indicative of an application started on the UE 110 when the UE 110 receives a control message, an application determination unit for determining whether an application used to process a request message addressed to the application on the UE 110 has been started on the UE 110, an application information transmitting unit for transmitting, to the UE 110, information for identifying an application used to process a request message addressed to the application when the application started on the UE 110 is not appropriate as the application used to process the request message addressed to the application on the UE 110, and an application identification information adding unit for adding, to the control message, information for identifying an application used to process a request message addressed to the application on the UE 110.

### Third Embodiment

Next, the third embodiment of the disclosed technique will be described. In the third embodiment of the disclosed technique, instead of the method for the UE 110 to transmit a control message transmission request to the network 120 in order to register filter information, a method for the server 130 to add a control message transmission request into a packet to be transmitted to the UE 110 will be described.

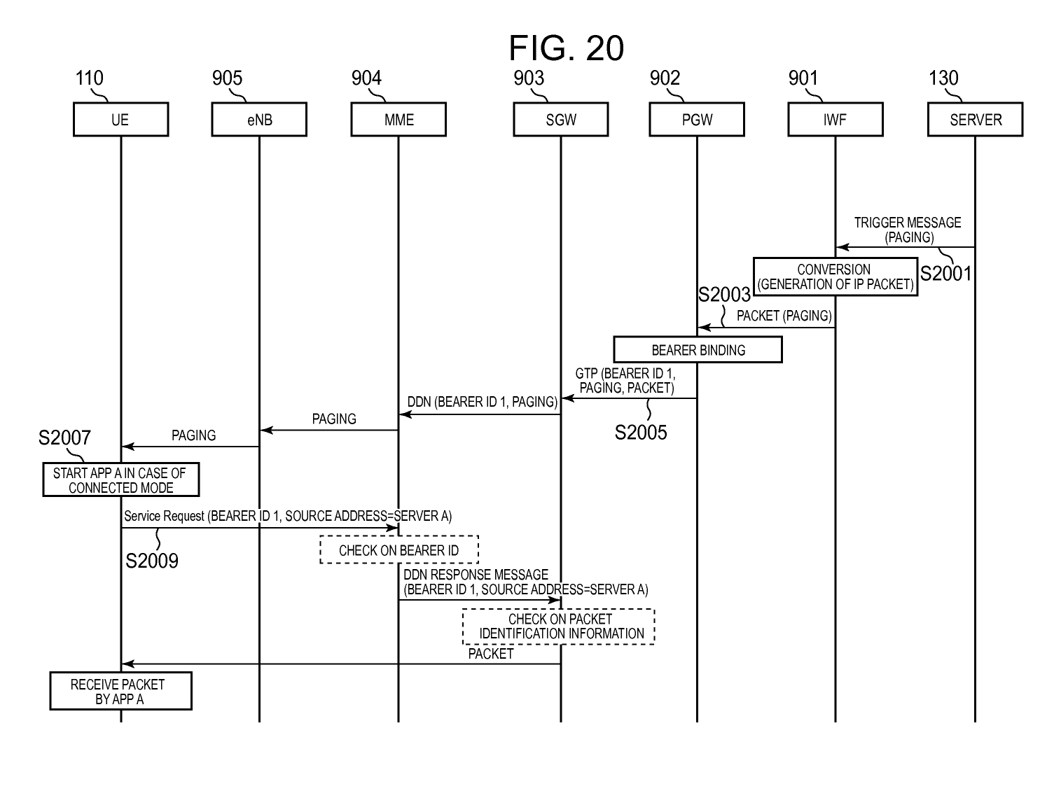

FIG. 20 is a sequence chart showing an example of processing when the server 130 adds a paging transmission request as the control message transmission request into a trigger message to be transmitted to the IWF 901 in the third embodiment of the disclosed technique. The following description will be made mainly about operations different from the first embodiment of the disclosed technique (points different from the sequence chart shown in FIG. 12) to omit the description of the same or similar operations as or to those of the first embodiment of the disclosed technique.

In FIG. 20, the server 130 adds, to a trigger message, a paging transmission request as a control message transmission instruction, and transmits the paging transmission request to the IWF 901 (step S2001). When the paging transmission request is added into the trigger message received, the IWF 901 adds the paging transmission request to a packet and transmits the packet to the PGW 902 (step S2003). When the packet is a packet with the paging transmission request added thereto, the PGW 902 that received the packet from the IWF 901 adds a paging request to a GTP message and transmits the GTP message (step S2005) like in the first embodiment of the disclosed technique. Even when the PMIP protocol is used on the interface between the PGW 902 and the SGW 903, the PGW 902 adds the paging request to a GRE header and transmits the paging request like in the first embodiment of the disclosed technique. As a result, when receiving the paging in the connected mode, the UE 110 starts application A (step S2007) and transmits a service request (step S2009). When the UE 110 is in the idle mode, paging is always received. However, even when receiving paging in the idle mode, the UE 110 may transmit the service request after starting application A.

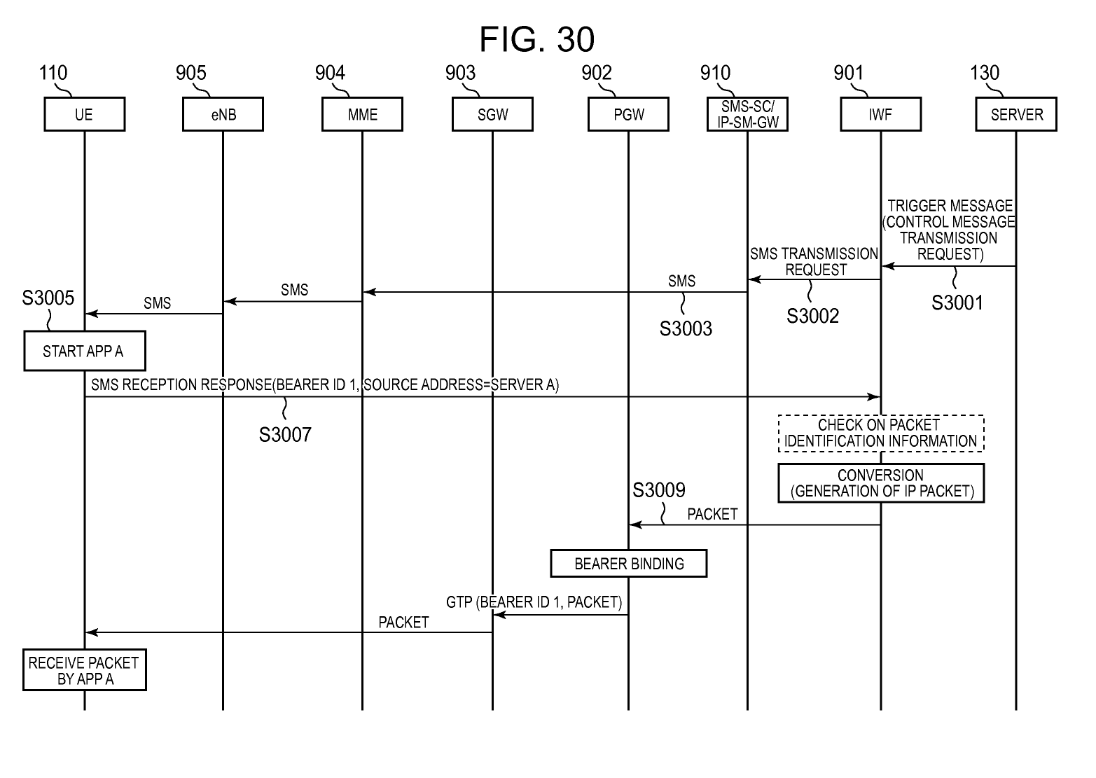

FIG. 30 is a sequence chart showing an example of processing when the server 130 includes a control message transmission request in the trigger message to be transmitted to the IWF 901 and the IWF 901 selects the use of SMS in the third embodiment of the disclosed technique. The following description will be made mainly about operations different from the first embodiment of the disclosed technique (points different from the sequence chart shown in FIG. 29) to omit the description of the same or similar operations as or to those of the first embodiment of the disclosed technique.

In FIG. 30, the server 130 adds a control message transmission instruction to a trigger message and transmits the trigger message to the IWF 901 (step S3001). When the control message transmission instruction is added to the trigger message received, the IWF 901 selects the use of SMS and transmits, to the SMS-SC/IF-SM-GW 910, a transmission request for SMS addressed to the UE 110 (step S3002). As a result, when receiving the SMS in the connected mode, the UE 110 starts application A (step S3005), and transmits an SMS reception response (step S3007). When the UE 110 is in the idle mode, the UE 110 receives the SMS after receiving paging and transmitting a service request. Then, the UE 110 transmits the SMS reception response after starting application A. The SMS reception response may be SMS or an IP packet.

The UE 110 may transmit the SMS reception response to the server 130. The SMS reception response may be transmitted to the server 130 through the MME 904, the SMS-SC 910, and the IWF 901. For example, the MME 904 that received the SMS reception response transmitted from the UE 110 may transmit a response (delivery report) indicating that the transmission of the trigger message to the SMS-SC 910 is completed, and the SMS-SC 910 may further transmit the response to the IWF 901. Further, the IWF 901 that received the response to the trigger message may transmit a response (message indicating that the transmission of the trigger message to the UE 110 is completed) to the server 130 as the source of the trigger message. In this case, after receiving the SMS reception response from the UE 110, the server 130 transmits a packet for application A to the UE 110. Further, In this case, the IWF 901 may omit the buffering of the trigger message received from the server 130. Further, the UE 110 that received paging and started the application may wait for the reception of a packet without returning the paging request response. In this case, the IWF 901 or the server 130 forwards the packet to the UE 110 after a predetermined time has elapsed.

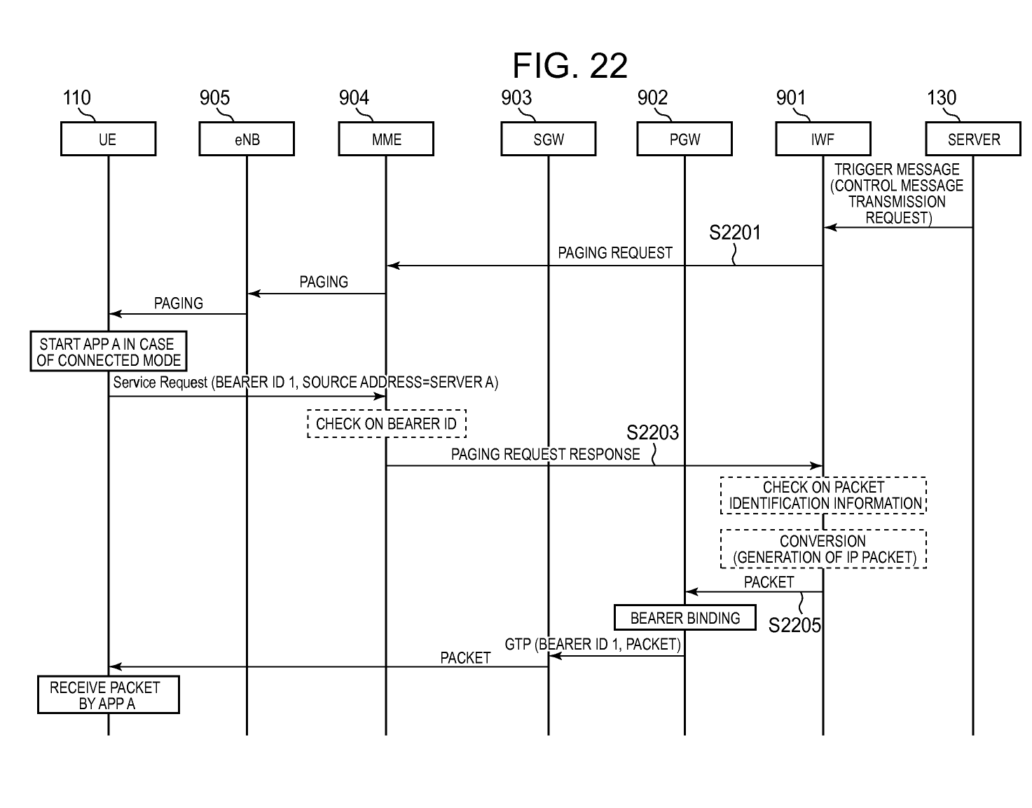

FIG. 22 is a sequence chart showing an example when the IWF 901 directly instructs the MME 904 to transmit paging in the third embodiment of the disclosed technique. The following description will be made mainly about points different from the sequence chart shown in FIG. 20 mentioned above to omit the description of the same or similar operations. The points different from FIG. 20 are as follows: When a paging transmission request is added into a trigger message received from the server 130, the IWF 901 instructs the MME 904 to transmit paging addressed to the UE 110 (step S2201). Then, when receiving a paging request response from the MME 904 (step S2203), the IWF 901 converts the buffered trigger message received from the server 130 to a packet addressed to the UE 110, and transmits the packet (step S2205). The packet is forwarded to the UE 110 through the established connection/bearer.

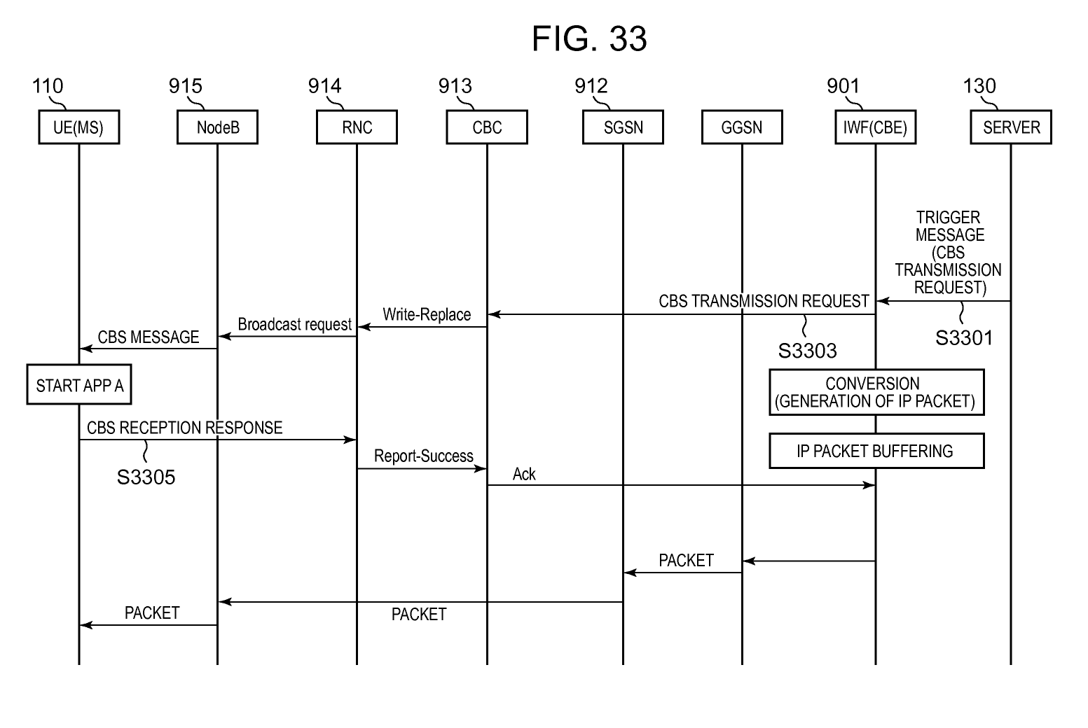

FIG. 33 is a sequence chart showing an example when the server 130 includes, in a trigger message, information (control message transmission request) for giving an instruction to use a CBS message and transmits the trigger message to the IWF 901, and the IWF 901 selects the use of CBS in the third embodiment of the disclosed technique.

The server 130 adds a control message transmission instruction (CBS transmission request) to the trigger message and transmits it to the IWF 901 (step S3301). When the control message transmission instruction is added into the trigger message received, the IWF 901 selects the use of CBS and requests the network to transmit a CBS message (broadcast message) (step S3303). When the trigger message received from the server 130 includes information to be notified to the UE 110 (e.g., information for identifying the ID of an application to be started or a message, and information on the connection to be established, such as APN, the URI of the server, or the IP address), the IWF 901 may instruct the network to include these pieces of information in the CBS message. As a specific method of transmitting the CBS message, the IWF 901 as CBE (Cell Broadcast Entity) requests the CBC (Cell Broadcast Center) 913 to transmit a CBS message addressed to the UE 110, and the CBC 913 transmits the CBS message to the UE 110 through the RNC 914 and the NodeB 915.

When receiving the CBS message addressed to itself, the UE 110 starts application A and returns a CBS message reception response to the IWF 901 through the network (step S3305). The IWF 901 that received the CBS message reception response transmits, to the UE 110, a packet generated based on the trigger message received from the server 130. As a specific example of a method of returning the reception response to the IWF 901, the UE 110 transmits the CBS reception response to the RNC 904. When the RNC 914 that received the CBS reception response transmits Report-Success to the CBC 913, Ack is transmitted from the CBC 913 to the IWF 901. As another example, the UE 110 may transmit the CBS reception response to the SGSN 912, and the SGSN 912 may transmit Ack to the IWF 901. In this case, a Service request can be used as the message to be transmitted to the SGSN 912. In this Service request, information (Information Element) for notifying the SGSN 912 that the message is the CBS reception response may be included.

When receiving Ack indicating that the UE 110 has attached to the network in response to receiving the CBS message, the IWF 901 generates an IP packet based on the trigger message received from the server 130, and transmits the IP packet to the UE 110. Thus, since the UE 110 can receive packets addressed to application A in the state of running application A, the need for buffering required when a packet is received before starting the application is also eliminated.

The server 130 may include, in the trigger message to be transmitted to the IWF 901, information indicating that the UE 110 as the destination is a UE that transmits a data packet in response to receiving a control message. In this case, the IWF 901 can recognize that there is no need to transmit, to the UE 110, a packet generated based on the trigger message.

In FIG. 20, FIG. 30, FIG. 22, and FIG. 33, when the UE 110 is stopping application A, or has stopped application A, or is about to stop application A, an application message may be transmitted to notify the server 130 that application A is stopped. Further, when there is a need to reduce the processing load to receive packets even if application A is running, the server 130 may be notified of that effect.

Further, when the UE 110 recognizes that congestion occurs in the network 120 due to the fact that a control message (connection/bearer establishment message, service request) related to data connection and transmitted from the UE 110 to the network 120 is rejected, the UE 110 may transmit a message to request the server 130 to transmit a trigger message instead of transmitting a data packet. If a back-off timer indicative of a time interval during which no message can be transmitted is included in a rejection message, the value may be included in a notification message to be transmitted to the server 130. In this case, the server 130 starts a timer after receiving the notification message, and transmits the trigger message to the UE 110 instead of transmitting a data packet after the time period corresponding to the value of the back-off timer has elapsed.

When receiving a stop notification of application A from the UE 110, since the server 130 can recognize that application A on the UE 110 is stopped, the server 130 transmits a trigger message including information for requesting the IWF 901 to transmit a control message (paging, SMS, or CBS) addressed to the UE 110. This enables the server 130 to transmit, to the UE 110, the control message addressed to the UE 110 that is stopping application A when the server 130 starts communication with the UE 110 instead of transmitting a data packet related to application A. The IWF 901 can determine to transmit a trigger message as the control message even when the UE 110 holds an established connection and bearer, rather than forwarding the trigger message as a data packet using the established connection. This allows the UE 110 to start application A using the reception of the control message as a trigger even when application A is stopped, allowing the UE 110 to start application A at appropriate timing before starting actual communication.

Note that identification information (the ID of the UE or the application ID) on the UE 110 may be included in the message notified from the UE 110 to the server 130 so that the server 130 can recognize the need to transmit a control message (control message as the trigger message) to the UE 110. This enables the server 130 to hold the identification information notified from the UE 110 in association with information indicative of a control message transmission request when receiving the notification message from the UE 110. Then, the server 130 refers to this held information when starting communication with the UE 110, and determines the need to transmit the control message, rather than a data packet, to the UE 110.

When notified from the network that the UE 110 has responded to the control message, the IWF 901 may forward the notification to the server 130. In this case, the server 130 that received the notification of the message indicating that the UE 110 has responded transmits a packet to the UE 110, rather than that the IWF 901 forwards, to the UE 110, a packet generated based on the trigger message. In other words, the server 130 transmits a trigger message for requesting the start of application A on the UE 110 or the attachment to the network and establishment of a connection by the UE 110, and as a result, after receiving the notification indicating that the UE 110 has responded to the control message (the UE 110 that received the control message has started application A, or has attached to the network and established a connection), the server 130 transmits a data packet to the UE 110. This can lead to a reduction in the load on the network or the IWF 901 due to the generation and buffering of the packet.

The server 130 may include, in a trigger message to be transmitted to the IWF 901, information indicating that this trigger message is a trigger message for requesting the UE 110 to start application A or attach to the network and establish a connection. In other words, when such information is included in the trigger message, the IWF 901 can recognize that there is no need to transmit, to the UE 110, a packet generated based on the trigger message.

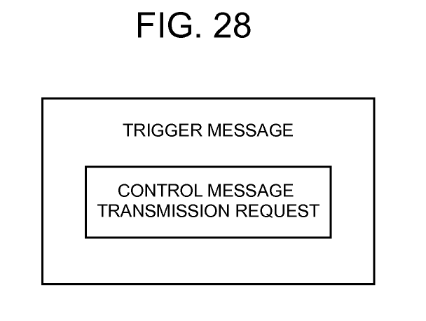

FIG. 28 schematically shows a trigger message transmitted from the server 130 in the third embodiment of the disclosed technique. In the trigger message transmitted from the server 130, a control message transmission request (control message transmission instruction) is included. The control message transmission request included in the trigger message may be represented in any form. For example, a flag may be set to indicate that the transmission of the control message is requested, or if information on the application (port number, or the like) as information necessary for conversion to an IP packet is not included, the transmission of the control message may be instructed. Further, if the IWF 901 has two addresses, both may be made so discriminable that one is used as the address of a trigger message including the control message transmission request and the other is used as the address of a trigger message that does not include the control message transmission request. The control message transmission request means requesting the forwarding of the trigger message to the UE 110 by a method (paging, SMS, CBS, or the like) without using the connection (PDP context/PDN connection) already established between the UE 110 and the network or a connection to be newly established.

The method described in the second embodiment of the disclosed technique can be combined to start an application required to receive packets when two or more applications exist on the UE 110 even in the third embodiment of the disclosed technique.

The technique described in the third embodiment of the disclosed technique is also effective in a case where it is not suited to transmit downlink data (Mobile Terminated Data) to the UE 110 in order to request the UE 110 not only to start an application on the UE 110 but also to transmit data (Mobile Originated Data).

For example, when an application running on the UE 110 does not respond to the reception of downlink data, the technique described in the third embodiment of the disclosed technique can be used. When the application does not respond to the reception of downlink packets, data packets sent from the server 130, a node within the cellular network, or any other UE 110 end up being discarded by the PGW 902 or the UE 110. For example, when no bearer is associated with a packet for the application in a TFT held by the PGW 902, the PGW 902 discards the packet without forwarding the packet. As other cases where the technique described in the third embodiment of the disclosed technique can be used, there are cases where downlink data is used to instruct the UE 110 to transmit data and where two or more UEs 110 are instructed at the same time. In these cases, since the amount of data traffic increases, there is a need to instruct the UE 110 to transmit data without using downlink data or to receive such an instruction. In such a case, this technique can be used. As will be described below, the server 130 recognizes that downlink data should not be transmitted to the UE 110 based on information indicating that the applications used by the UE 110 have the above characteristics, and transmits, to the IWF 901 the trigger message with the control message transmission request added thereto.

The technique described in the third embodiment of the disclosed technique is further effective in requesting the UE 110 to attach to the network, and/or to establish a new connection.

For example, when transmitting, to the IWF 901, a trigger message addressed to the UE 110 to communicate with the UE 110, if no connection has been established between the UE 110 and the network where the server 130 resides, the server 130 will add the control message transmission request to the trigger message. This includes a case where it is determined that, even when the UE 110 has an established connection, the connection is not suited to forward the trigger message as a data packet, or a case where it is determined that the connection is not suited to forward data in communication to be started from now. The term “not suited” means, for example, a case where the APN (Access Point Name) of the existing connection is different from an APN in the communication to be newly started, or a case where the QoS of the existing connection does not fit the new communication (when the resources or QoS is not sufficient). The server 130 may transmit a trigger message as the control message transmission request by including data (application data) to be notified to the UE 110 therein. In this case, the IWF 901 performs processing for transmitting the trigger message including the data (SMS, CBS, MBMS, ETWS, NAS, etc.) to the UE 110.

Further, when stating communication with the UE 110, the server 130 may compare which of the unit for transmitting the trigger message using the control message and the unit for transmitting the trigger message using a data packet related to the application is appropriate from an arbitrary perspective (cost, communication charge, traffic state, traffic load, transmitted message size, number of transmitted messages, security level, application type, etc.) to select either unit determined to be more appropriate. For example, when the communication charge or the number of transmitted messages in the case of transmitting the trigger message as the control message is less than that in the case of transmitting the trigger message as the data packet (for example, when two or more addresses of UEs 110 can be included in one control message, or when a group ID to which two or more UEs 110 belong can be specified as the address), the transmission of the trigger message using the control message is requested. In general, since only one IP address can be set in an IP packet, the use of the control message is efficient when it is desired to transmit the message to the two or more UEs 110 at the same time.

Further, when the communication charge in the case of transmission included in the control message is less than that in the case of the transmission of data to be transmitted to the UE 110 as a data packet, the transmission of the trigger message using the control message is requested. When there are plural kinds (SMS, CBS, MBMS, NAS) as the trigger message to be transmitted to the UE 110, it may be further determined which kind of control message is appropriate so that the result will be added to the trigger message to be transmitted to the IWF 901.

Since SMS and CBS messages are not messages that guarantee real-time notification, the server 130 may determine to transmit the trigger message using the control message when the communication performed with the UE 110 is non-real-time communication, or to use the data packet when the communication is real-time communication. When the content (destination, source, data, etc.) of the trigger message does not change over time, the server 130 may determine to transmit the trigger message using the control message. When the transmission of the data packet to the UE 110 could cause switching among gateways (P-GW, S-GW, ePDG) managing connections for data communication of the UE 110, the server 130 may determine to transmit the trigger message using the control message.

When the size of data (application data) desired to transmit to the UE 110 is below a defined value, the server 130 may request the IWF 901 to transmit the control message including data as the trigger message instead of transmitting the data packet directly to the UE 110. The defined value in this case may be the upper limit value of data size capable of being included according to the kind of trigger message to be transmitted to the UE 110 (e.g., Mobile Terminated SMS, CBS, or NAS). As the size of data to be transmitted to the UE 110, a value notified from an application and used for the communication with the UE 110 may be used. Further, the application may determine the size of transmitted data based on the application data received from the UE 110 before the transmission of the trigger message.

When the size of data desired to receive from the UE 110 is below the defined value, the server 130 may request the IWF 901 to transmit the control message as the trigger message instead of transmitting the data packet to the UE 110. In this case, the UE 110 that received the trigger message can determine to transmit data to be transmitted to the server 130 by including it in a control message (Mobile Originated SMS, NAS) instead of transmitting it as a data packet.

Further, when recognizing that congestion (U-plane congestion) occurs in the network 120 due to the data packet, the server 130 may request the IWF 901 to transmit a control message including data as the trigger message. On the other hand, when recognizing that congestion (C-plane congestion) occurs in the network 120 due to the control message, the server 130 may determine to transmit a data packet related to the application directly to the UE 110.

As described above, information to be referred to by the server 130 in determining whether to request the IWF to transmit the trigger message using the control message or to transmit the data packet related to the application directly to the UE 110 may be information notified from the UE 110 before the transmission of the trigger message. In other words, the UE 110 gives notice of the information to be referred to by the server 130 in selecting a trigger message transmission method according to the state of the application.

In the message notified from the UE 110 to the server 130, identification information (the ID of the UE or the application ID) on the UE 110 may be included so that the server 130 can recognize the need to transmit a control message (control message as the trigger message) to the UE 110. This enables the server 130 to hold the identification information notified from the UE 110 in association with information indicative of a control message transmission request when receiving the notification message from the UE 110. Then, the server 130 refers to this held information when starting communication with the UE 110, and determines the need to transmit the control message, rather than a data packet, to the UE 110.

In the above description, the determinations made by the server 130 are described individually, but when the determinations are made based on multiple conditions, the server 130 follows the determination results based on higher-priority conditions.

Thus, the IWF 901 forwards the trigger message using the control message according to the control message transmission request included in the trigger message addressed to the UE 110 and received from the server 130 so that the IWF 901 can instruct the UE 110 to establish a connection capable of being used to forward a data packet in the communication.

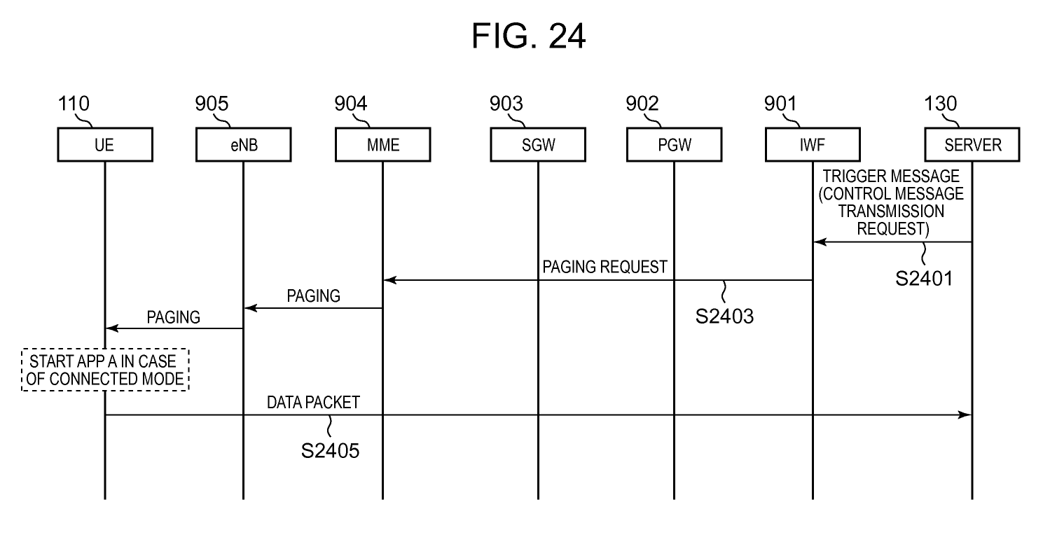

FIG. 24 is a sequence chart showing an example when paging is used as the control message to trigger data transmission from the UE 110 in the third embodiment of the disclosed technique. The following description will be made mainly about points different from the sequence chart shown in FIG. 20 mentioned above to omit the description of the same or similar operations. In the above case, the server 130 transmits, to the IWF 901, a trigger message with a control message transmission request added to a trigger message to be transmitted to the UE 110 (step S2401). The IWF 901 selects the use of paging as the control message and requests the MME 904 to transmit the paging (step 2403). Then, when receiving the paging, an application on the UE 110 uses this paging as a trigger to start the transmission of data to the server 130, a node within the cellular network, or any other UE 110 (step S2405). When the application is not running upon receiving the paging, the UE 110 starts data transmission after starting the application. The data to be transmitted from the UE 110 may be transmitted as an IP packet or as SMS including the data. When the UE 110 is in the idle mode, paging is always received, but even when receiving paging in the idle mode, the UE 110 may start data transmission to the server 130, a node within the cellular network, or any other UE 110 after transmitting a service request. As another operation of the UE 110 upon receiving the paging, a new connection to the network may be established.

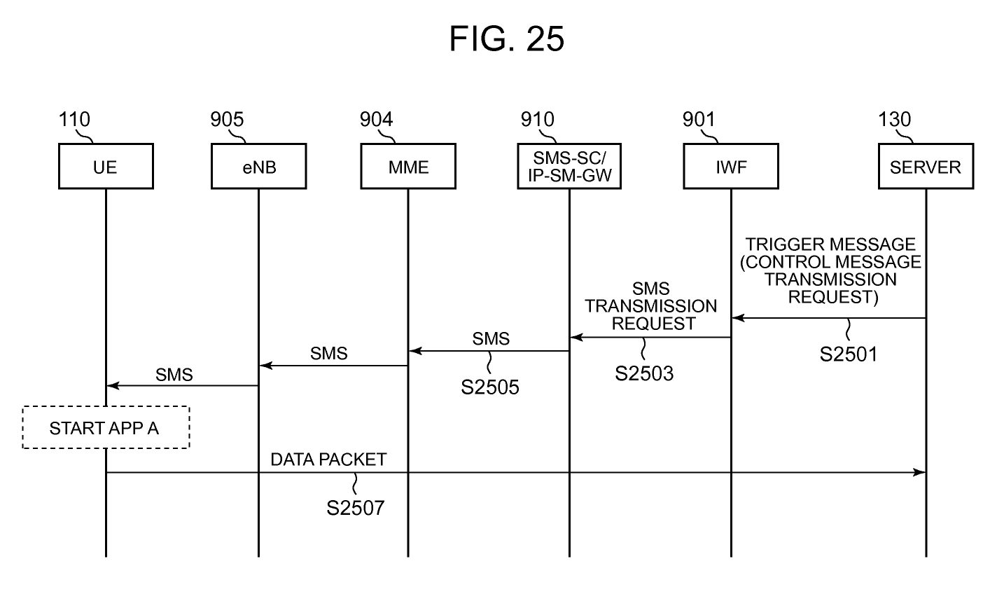

FIG. 25 is a sequence chart showing an example when SMS is used as the control message to trigger data transmission from the UE in the third embodiment of the disclosed technique. In the above case, the server 130 transmits, to the IWF 901, a trigger message with a control message transmission request (SMS transmission request) added to a trigger message to be transmitted to the UE 110 (step S2501). When receiving the trigger message from the server 130, the IWF 901 determines the use of SMS as the control message and requests the network 120 to transmit SMS addressed to the UE 110. Specifically, the IWF 901 requests the SMS-SC/IP-SM-GW 910 to transmit the SMS (step S2503). Thus, for example, the SMS-SC/IP-SM-GW 910 transmits the SMS to the UE 110 (step S2505). The UE 110 receives the SMS through a DownLink NAS Transport message transmitted from the MME 904.

An application on the UE 110 that received the SMS uses this SMS as a trigger to start data transmission to the server 130, a node within the cellular network, or any other UE 110 (step S2507). When the application is not running upon receiving the SMS, the UE 110 starts data transmission after starting the application. A layer (Service Capability Layer) for receiving SMS starts an appropriate application based on application information included in the SMS. The data to be transmitted from the UE 110 may be transmitted as an IP packet or SMS including the data. When the UE 110 is in the idle mode, the UE 110 receives paging, and receives SMS after transmitting a service request. Then, after receiving the SMS, the UE 110 starts data transmission. Thus, since data transmission from the UE 110 can be requested without using downlink data, an increase in the amount of data traffic can be prevented. Even if the IF address of the UE 110 that the server 130 knows has been changed, a message can also be delivered to the UE 110. As another operation of the UE 110 upon receiving the SMS, a new connection to the network may be established.

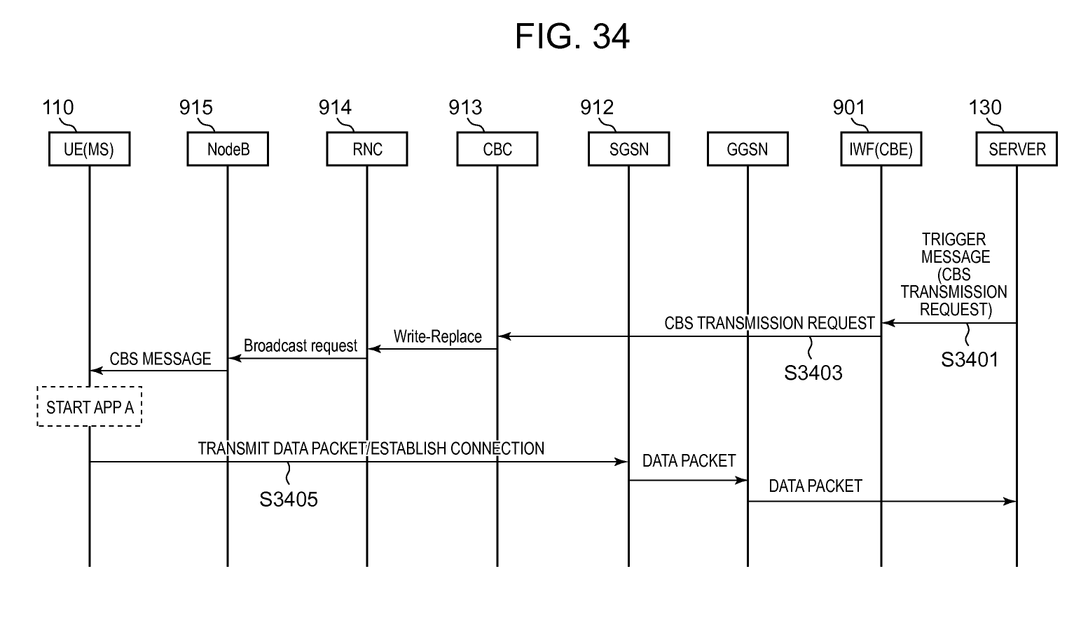

FIG. 34 is a sequence chart showing an example when the server 130 includes, in a trigger message, information (control message transmission request) for giving an instruction to use a CBS message and transmits the trigger message to the IWF 901, and the IWF 901 selects the use of CBS in the third embodiment of the disclosed technique.

The server 130 includes, in a trigger message to be transmitted to the IWF 901, a control message transmission instruction (CBS transmission request) for giving an instruction to use a CBS message, and transmits the trigger message (step S3401). When information for giving the instruction to use a CBS message is included in the trigger message received from the server 130, the IWF 901 requests the network to transmit the CBS message (step S3403). When the trigger message received from the server 130 includes information to be notified to the UE 110 (e.g., information for identifying an application to be started or a message, and information on the connection to be established, such as APN, the URI of the server, or the IP address), the IWF 901 may instruct the network to include these pieces of information in the CBS message. As a specific method of transmitting the CBS message, the IWF 901 as CBE (Cell Broadcast Entity) requests the CBC (Cell Broadcast Center) 913 to transmit a CBS message addressed to the UE 110, and the CBC 913 transmits the CBS message to the UE 110 through the RNC 914 and the NodeB 915. The IWF 901 may include, in the CBS message to be transmitted, only the ID of the UE 110 as an ID for identifying the UE to receive or the ID of a group to which the UE 110 belongs. When receiving the CBS message addressed to itself, the UE 110 transmits a data packet related to application A to the server 130 (step S3405). When application A is not started yet, the UE 110 transmits the data packet to the server 130 after starting application A. As another operation of the UE 110 upon receiving the CBS, a new connection to the network may be established.

In FIG. 24, FIG. 25, and FIG. 34, when the UE 110 has stopped (paused) application A, the UE 110 may transmit a message (data packet) for notifying the server 130 that application A has been stopped. When starting communication with the UE 110 after receiving a stop notification of application A from the UE 110, the server 130 transmits, to the IWF 901, a trigger message including information for requesting the transmission of a control message (paging, SMS, CBS, or the like) addressed to the UE 110, rather than transmitting a data packet addressed to the UE 110. The message transmitted from the UE 110 to the server 130 is not a notification of the trigger message in the data packet using a connection, and the format is no object as long as the message includes information indicating that the notification of the trigger message is required by another method without using the connection. For example, the message may be transmitted as application data generated by application A. This enables the server 130 to request the transmission of a control message addressed to the UE 110, instead of transmitting a data packet to the UE 110 on which application A is stopped, when starting communication with the UE 110. On the other hand, the IWF 901 that received the trigger message including the control message transmission request can determine to transmit the trigger message as the control message, rather than forwarding the trigger message as data packet using an established connection even if the UE 110 hold the established connection and bearer. In the UE 110 that received the control message, the control message receiving unit 704 and the application control unit 705 start appropriate application A based on information (application ID, or the like) included in the control message, and started application A transmits a necessary data packet to start communication with the server 130.

Thus, when the UE 110 is stopping application A, since the trigger message transmitted from the server 130 can be received as the control message rather than the data packet, appropriate processing such as to start application A can be performed. When information notified through the message transmitted from the UE 110 to the server 130 as mentioned above is held in the HLR/HSS 906, the IWF 901 may refer to the HLR/HSS 906 to acquire information on the UE 110, and when the information gives an instruction to use the control message, the IWF 901 may determine to transmit, as the control message, the trigger message received from the server 130 to the UE 110.

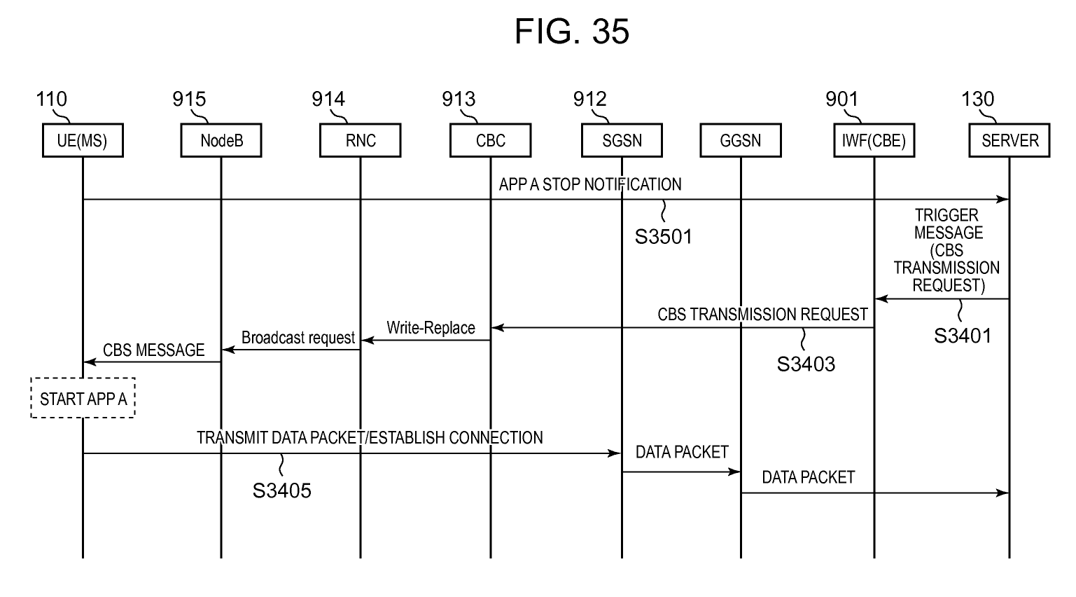

FIG. 35 represents a sequence when the server 130 includes a CBS transmission request in a trigger message and transmits the trigger message in response to receiving an application stop notification from the UE 110. FIG. 35 shows a case where, in the sequence shown in FIG. 34, the UE 110 transmits an app A stop notification message when stopping application A (step S3501), and the server 130 recognizes that application A on the UE 110 is stopped so that the server 130 can transmit the trigger message, for example, when starting communication with the UE 110. Likewise, in the sequences shown in FIG. 24 and FIG. 25, if the UE 110 transmits the app A stop notification message when stopping application A, since the server 130 can recognize that application A on the UE 110 is stopped, the server 130 can transmit the trigger message as paging or SMS, rather than transmitting the trigger message as a data packet. This allows the UE 110 to start application A using the reception of the control message as a trigger even when application A is not running, allowing the UE 110 to start application A at appropriate timing before starting actual communication.

As described in the first embodiment of the disclosed technique, notification information such as an SIB (System Information Block) transmitted from a base station can also be used as a control message transmitted from the network 120 to the UE 110 even in the third embodiment of the disclosed technique. In this case, upon receiving paging, when information indicative of the presence or absence of a change in SIB is included in the paging, the UE 110 checks on a corresponding SIB, and when information indicative of a packet reception notification is included therein, the UE 110 starts application A to return a response message or to start data transmission to the server 130, a node within the cellular network, or any other UE 110.

The server 130 may transmit, to the PGW 902 or the IWF 901, a trigger message with a specific control message such as paging or SMS specified therein, or transmit a trigger message with no control message particularly specified. In the latter case, when receiving, from the server 130, the trigger message with a control message transmission request added thereto, the PGW 902 or the IWF 901 determines which control message is used to trigger the UE 110. Like the UE 110 in the first embodiment of the disclosed technique, the server 130 may also register filter information with the PGW 902 or the IWF 901. In this case, the server 130 does not need to add the control message transmission request to the trigger message. A node for managing information on the UE 110 may be provided within the 3GPP network 120 so that the UE 110 will register filter information with the node. In this case, the PGW 902 or the IWF 901 may make an inquiry to the node managing the information on the UE 110 to determine whether to transmit a control message to the UE 110.

As described above, according to the third embodiment of the disclosed technique, since the need for a data packet to request the UE 110 to transmit data is eliminated, network traffic can be reduced. Further, since a data packet transmission request for an application that is not running can be notified to the UE 110, the UE 110 can transmit a packet after starting the application using the reception of a control message as a trigger. Thus, power consumption and memory consumption due to the CPU power and CPU operation for keeping the application always running can be reduced.

### Fourth Embodiment

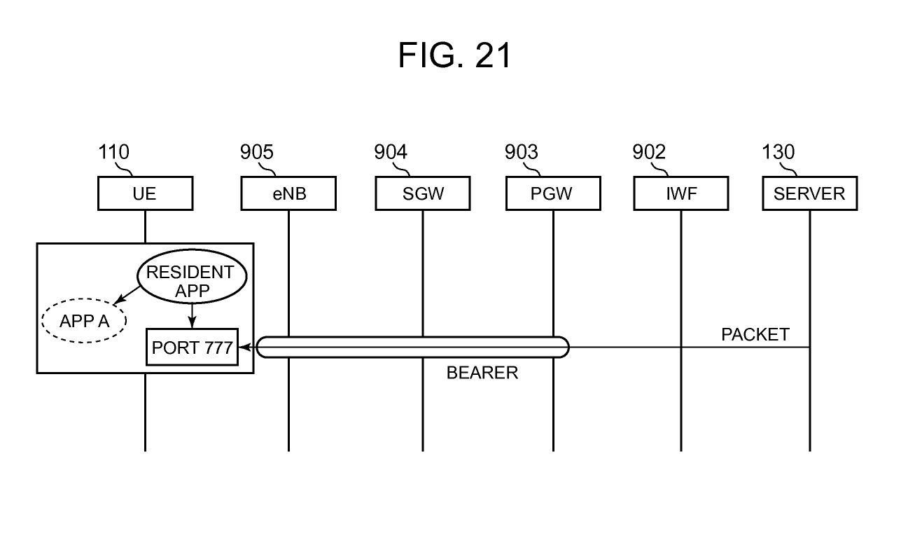

Next, the fourth embodiment of the disclosed technique will be described. FIG. 21 is a diagram showing an example of a method using a resident application for detecting that a packet addressed to application A has arrived on the UE 110 in the fourth embodiment of the disclosed technique. As shown in FIG. 21, an app for monitoring a port number (e.g., port number 777) used by application A is made resident on the UE 110. When this port monitoring app detects that a packet has arrived at a port number to be monitored, an application using the port number is started, and the arrived packet is passed to the running application. Since this port monitoring app can also be used for other applications for general purposes, the port monitoring app only has to be started instead of starting each individual application, enabling a reduction in power consumption and memory consumption due to the CPU power and CPU operation.

One aspect of the disclosed technique is a user terminal for performing communication with a predetermined communication device through a network, wherein the user terminal can include:

a control message receiving unit for receiving, from the network, a control message including application identification information for identifying an application on the user terminal, the control message being generated based on a request message, and the request message being transmitted from the predetermined communication device and including the application identification information; and

an application starting unit for starting an application identified by the application identification information when the control message is received at the control message receiving unit.

According to the above configuration, the user terminal can start an application used to receive and process a message for the application before receiving the message for the application from a terminal as the communication partner such as a server or any other user terminal.

In the one aspect of the disclosed technique, the user terminal may further include a response message transmitting unit for transmitting a response message indicative of the start of the application to the network when the application starting unit starts the application.

In the one aspect of the disclosed technique, the user terminal may further include a control message transmission requesting unit for transmitting, to the predetermined communication device, a control message transmission request for requesting the predetermined communication device to transmit the request message to the network.

In the one aspect of the disclosed technique, the control message transmission requesting unit may transmit the control message transmission request to the predetermined communication device when quitting a specific application on the user terminal.

In the one aspect of the disclosed technique, the user terminal may further include an identification information adding unit for adding, to the control message transmission request, identification information for identifying a message addressed to an application on the user terminal.

In the one aspect of the disclosed technique, the user terminal may use SMS as the control message.

Another aspect of the disclosed technique is a communication device for performing communication with a user terminal through a network, wherein the communication device can include

a message transmission unit for transmitting, to the network, a request message including application identification information for identifying an application on the user terminal, the request message requesting a network device including a network entity that is an element of the network to transmit a control message to the user terminal.

According to the above configuration, the user terminal can start an application used to receive and process a message for the application before receiving the message for the application from a terminal as the communication partner such as a server or any other user terminal.

In the other aspect of the disclosed technique, the communication device may further include a message forwarding unit for forwarding, to the user terminal, a data packet related to an application when receiving, from the user terminal, a response message indicating that the application has been started on the user terminal based on the reception of the control message.

In the other aspect of the disclosed technique, the communication device may further include a control message transmission request holding unit for holding a control message transmission request when receiving, from the user terminal, the control message transmission request for requesting the transmission of the request message to the network,

Wherein, upon starting communication with the user terminal, the message transmission unit transmits the request message to the network in case that the control message transmission request is held in the control message transmission request holding unit.

In the other aspect of the disclosed technique, the message transmission unit in the communication device may transmit the request message to the network device based on the control message transmission request received from the user terminal.

In the other aspect of the disclosed technique, the communication device may request the use of SMS as the control message.

Note, for example, that the above aspects of the disclosed technique can be combined arbitrarily. Further, in addition to the communication system, the user terminal, and the communication device, the aspects of the disclosed technique may be implemented by a method executed by the user terminal, the communication device, or the network device including network entities that make up the network, by a program for causing a computer to execute this method, and by a recording medium on which this program is recorded.

Each functional block and each processing unit used in the description of each of the aforementioned embodiments can be implemented in hardware, software, or a combination thereof. For example, each functional block included in each device shown in FIG. 7, 8, 10, or 11, or each processing unit having an equivalent function may be implemented by hardware components of any computer, such as a CPU and a memory. Further, each functional block or each processing unit may be realized by causing a computer to execute a program describing an operation related to each function.

Further, each functional block used in the description of each of the aforementioned embodiments can be realized as an LSI (Large Scale Integration) that is typically an integrated circuit. Each functional block can be individually formed into a single chip, or some or all of the functional blocks can be included and formed into a single chip. Although referred to here as the LSI, the integrated circuit may be referred to as an IC, a system LSI, a super LSI, or an ultra LSI depending on differences in integration. The method of forming the integrated circuit is not limited to LSI and can be actualized by a dedicated circuit or a general-purpose processor. An FPGA (Field Programmable Gate Array) that can be programmed after LSI manufacturing or a reconfigurable processor of which connections and settings of the circuit cells within the LSI can be reconfigured may be used. Further, if a technology for forming the integrated circuit that can replace LSI is introduced as a result of the advancement of semiconductor technology or a different derivative technology, the integration of the functional blocks can naturally be performed using the technology. For example, the application of biotechnology is a possibility.

### INDUSTRIAL APPLICABILITY

The disclosed technique allows the user terminal to start an application used to receive and process a message for the application before receiving the message for the application from a terminal as the communication partner such as a server or any other user terminal, having the effects of reducing the processing load on and the battery consumption of the user terminal. The disclosed technique is applicable to communication technology using a cellular communication function.

1. A communication system comprising:
a user terminal, a network device including a network entity that is an element of a network, and a predetermined communication device as a communication partner of the user terminal,
wherein
the predetermined communication device includes
a message transmission unit for transmitting, to the network, a request message including application identification information for identifying an application on the user terminal, the request message requesting the network device to transmit a control message to the user terminal,
the network device includes
a control message transmitting unit for transmitting a control message including the application identification information to the user terminal when receiving the request message from the predetermined communication device as the communication partner of the user terminal, the control message being generated based on the request message, and
the user terminal includes
a control message receiving unit for receiving the control message from the network, and
an application starting unit for starting an application identified by the application identification information when the control message is received at the control message receiving unit.

2. A user terminal for performing communication with a predetermined communication device through a network, comprising:
a control message receiving unit for receiving, from the network, a control message including application identification information for identifying an application on the user terminal, the control message being generated based on a request message, and the request message being transmitted from the predetermined communication device and including the application identification information; and
an application starting unit for starting an application identified by the application identification information when the control message is received at the control message receiving unit.

3. The user terminal according to claim 2, further comprising a response message transmitting unit for transmitting a response message indicative of the start of the application to the network when the application starting unit starts the application.

4. The user terminal according to claim 2, further comprising a control message transmission requesting unit for transmitting, to the predetermined communication device, a control message transmission request for requesting the predetermined communication device to transmit the request message to the network.

5. The user terminal according to claim 4, wherein the control message transmission requesting unit transmits the control message transmission request to the predetermined communication device when quitting a specific application on the user terminal.

6. The user terminal according to claim 4, further comprising an identification information adding unit for adding, to the control message transmission request, identification information for identifying an application on the user terminal.

7. The user terminal according to claim 2, wherein the user terminal uses SMS as the control message.

8. A communication device for performing communication with a user terminal through a network, comprising
a message transmission unit for transmitting, to the network, a request message including application identification information for identifying an application on the user terminal, the request message requesting a network device including a network entity that is an element of the network to transmit a control message to the user terminal.

9. The communication device according to claim 8, further comprising a message forwarding unit for forwarding, to the user terminal, a data packet related to an application when receiving, from the user terminal, a response message indicating that the application has been started on the user terminal based on reception of the control message.

10. The communication device according to claim 8, further comprising
a control message transmission request holding unit for holding a control message transmission request when receiving, from the user terminal, the control message transmission request for requesting transmission of the request message to the network,
wherein, upon starting communication with the user terminal, the message transmission unit transmits the request message to the network in case that the control message transmission request is held in the control message transmission request holding unit.

11. The communication device according to claim 8, wherein the message transmission unit transmits the request message to the network device based on the control message transmission request received from the user terminal.

12. The communication device according to claim 8, wherein the communication device requests the use of SMS as the control message.
